(19) United States
(12) Patent Application Publication
(10) Pub. No.: US 2022/0179141 A1
(43) Pub. Date: Jun. 9, 2022

(54) OPTICAL FILTER AND IMAGING DEVICE

(71) Applicant: AGC Inc., Tokyo (JP)

(72) Inventors: Kazuhiko SHIONO, Fukushima (JP); Sayuri YAMADA, Fukushima (JP); Yayoi YAMAMORI, Fukushima (JP)

(73) Assignee: AGC Inc., Tokyo (JP)

(21) Appl. No.: 17/651,911

(22) Filed: Feb. 22, 2022

Related U.S. Application Data
(63) Continuation of application No. PCT/JP2020/033687, filed on Sep. 4, 2020.

(30) Foreign Application Priority Data
Sep. 11, 2019 (JP) 2019-165682

(51) Int. Cl. G02B 5/22; C09B 57/00; G02B 5/00

(52) U.S. Cl. CPC G02B 5/223; G02B 5/003; C09B 57/007

(57) ABSTRACT

The present invention relates to an optical filter including an absorption layer containing a near-infrared absorbing dye and a resin, in which the near-infrared absorbing dye contains a squarylium dye having a maximum absorption wavelength in 650 to 780 nm and a thermal decomposition temperature of 265° C. or higher and satisfying IR20−IR80<65 nm, and the resin has a glass transition temperature of 390° C. or higher.

### TECHNICAL FIELD

The present invention relates to an optical filter that transmits light in a visible wavelength region and shields light in a near-infrared wavelength region, and an imaging apparatus including the optical filter.

### BACKGROUND ART

In an imaging apparatus using a solid-state image-sensing device, an optical filter, which transmits light in a visible region (hereinafter, also referred to as “visible light”) and shields light in a near-infrared region (hereinafter, “near-infrared light”), is used in order to reproduce color tone well and obtain a clear image. As the optical filter, a near-infrared cut filter including an absorption layer containing a near-infrared absorbing dye and a resin and a reflection layer formed of a dielectric reflection layer that shields near-infrared light, which are provided on a transparent substrate, has been known (See Patent Document 1).

Here, when mounting the optical filter, soldering is performed. In recent years, with the downsizing and weight reduction of the imaging apparatus and owing to capability of automation of the work, soldering by a reflow method has been adopted.

### CITATION LIST

### Patent Literature

Patent Literature 1: JP-A-2012-103340

### SUMMARY OF INVENTION

### Technical Problem

The soldering by the reflow method is a method where a solder paste is printed on a mounting substrate, components to be mounted are placed thereon, and then the whole is heated to melt solder. In the optical filter, at the time when the optical filter and the mounting substrate are soldered together, heat is indirectly propagated to the absorption layer containing a dye and a resin, and the temperature reaches 260° C. or higher. Under such a high temperature, the dye, which is an organic substance, may be thermally deteriorated. In addition, there may occur such appearance abnormality that the resin is thermally decomposed to generate bubbles or the adhesiveness to the transparent substrate is lowered.

The optical filter described in Patent Document 1 has room for improvement in terms of heat resistance.

Accordingly, an object of the present invention is to provide an optical filter having excellent heat resistance, which has excellent light shielding properties of near-infrared light and is less likely to generate thermal deterioration or appearance abnormality even when soldering is performed by the reflow method.

### Solution to Problem

The present invention relates to the following optical filter and imaging apparatus.

<1> An optical filter including an absorption layer containing a near-infrared absorbing dye and a resin, in which the near-infrared absorbing dye contains a squarylium dye satisfying all of the following characteristics (i-1) to (i-3) and the resin has a glass transition temperature of 390° C. or higher:

(i-1) when spectral transmittance is measured after dissolving in dichloromethane, the squarylium dye has a maximum absorption wavelength in 650 to 780 nm;

(i-2) the squarylium dye has a thermal decomposition temperature of 265° C. or higher; and

(i-3) in a spectral transmittance curve measured when the squarylium dye is dissolved in dichloromethane so that transmittance at the maximum absorption wavelength is 10%, IR20−IR80<65 nm is satisfied, where IR80 represents a wavelength at a transmittance of 80% in a wavelength range of 600 to 800 nm and IR20 represents a wavelength at a transmittance of 20% in a wavelength range of 600 to 800 nm.

<2> The optical filter according to <1>, in which the squarylium dye satisfies all of the following characteristics (i-4) to (i-6) in the spectral transmittance curve measured when the squarylium dye is dissolved in dichloromethane so that transmittance at the maximum absorption wavelength is 10%:

(i-4) IR20−IR80<60 nm is satisfied;

(i-5) an average transmittance of light in a wavelength range of 400 to 500 nm is 96% or more; and

(i-6) a minimum transmittance of light in a wavelength range of 400 to 500 nm is 93% or more.

<3> The optical filter according to <1> or <2>, in which the squarylium dye satisfies all of the following characteristics (i-7) to (i-11) in a spectral transmittance curve measured when the squarylium dye is dissolved in a resin so that transmittance at the maximum absorption wavelength is 10%:

(i-7) a maximum absorption wavelength is in a range of 650 to 790 nm;

(i-8) IR20 is in a range of 630 to 770 nm;

(i-9) IR20−IR80<80 nm is satisfied;

(I-10) an average transmittance of light in a wavelength range of 400 to 500 nm is 90% or more; and

(i-11) a minimum transmittance of light in a wavelength range of 400 to 500 nm is 85% or more.

<4> The optical filter according to any one of <1> to <3>, in which the squarylium dye is a compound represented by the following Formula (I) or (II).

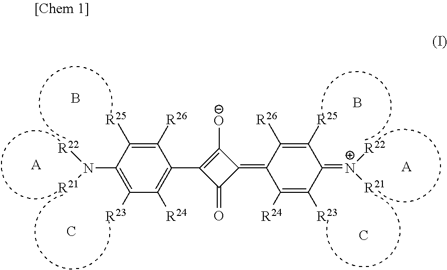

Here, symbols in Formula (I) are as follows.

R²⁴ and R²⁶ each independently represents a hydrogen atom, a halogen atom, a hydroxy group, an alkyl group or alkoxy group having a carbon number of 1 to 6, an acyloxy group having a carbon number of 1 to 10, —NR²⁷R²⁸ (R²⁷ and R²⁸ each independently represents a hydrogen atom, an alkyl group having a carbon number of 1 to 20, —C(═O)—R²⁹ (R²⁹ represents a hydrogen atom or a hydrocarbon group having a carbon number of 1 to 25 which may have a substituent and may contain an unsaturated bond, an oxygen atom, or a saturated or unsaturated ring structure between carbon atoms), —NHR³⁰, or —SO₂—R³⁰ (R³⁰ represents a hydrocarbon group having a carbon number of 1 to 25, each of which one or more hydrogen atoms may be substituted with a halogen atom, a hydroxy group, a carboxy group, a sulfo group, or a cyano group, and which may contain an unsaturated bond, an oxygen atom, or a saturated or unsaturated ring structure between carbon atoms)), or a group represented by the following Formula (S) (R⁴¹ and R⁴² each independently represents a hydrogen atom, a halogen atom, or an alkyl group or alkoxy group having a carbon number of 1 to 10, and k is 2 or 3).

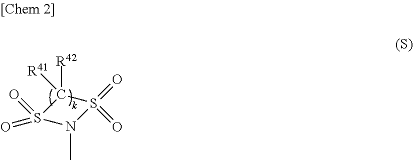

R²¹ and R²², R²² and R²⁵, and R²¹ and R²³ may be bonded to each other to form a heterocycle A, a heterocycle B, and a heterocycle C each having 5 or 6 members together with the nitrogen atom, respectively.

R²¹ and R²² in the case where the heterocycle A is formed represent, as a divalent group -Q- to which they are bonded, an alkylene group or alkyleneoxy group in which a hydrogen atom may be substituted with an alkyl group having a carbon number of 1 to 6, an aryl group having a carbon number of 6 to 10, or an acyloxy group having a carbon number of 1 to 10 which may have a substituent.

R²² and R²⁵ in the case where the heterocycle B is formed, and R²¹ and R²³ in the case where the heterocycle C is formed respectively represent, as divalent groups —X¹—Y¹— and —X²—Y²— (X¹ and X² are on the side that bonds to nitrogen) to which they are bonded, a group in which X¹ and X² are each a group represented by the following Formula (1x) or (2x), and Y¹ and Y² are each a group represented by any one selected from the following Formulae (1y) to (5y). In the case where X¹ and X² are each a group represented by the following Formula (2x), Y¹ and Y² may be a single bond, and in that case, an oxygen atom may be contained between carbon atoms.

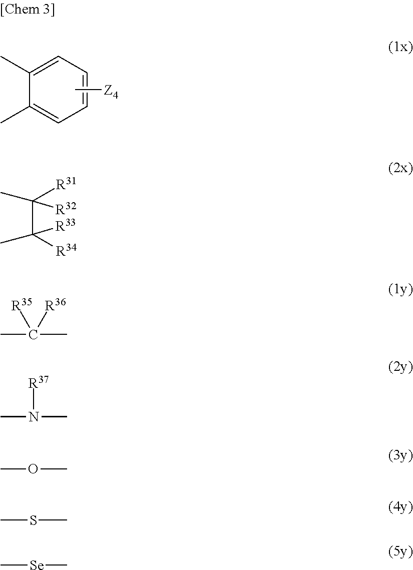

In Formula (1x), four Z's each independently represents a hydrogen atom, a hydroxy group, an alkyl group or alkoxy group having a carbon number of 1 to 6, or —NR³⁸R³⁹ (R³⁸ and R³⁹ each independently represents a hydrogen atom or an alkyl group having a carbon number of 1 to 20). R³¹ to R³⁶ each independently represents a hydrogen atom, an alkyl group having a carbon number of 1 to 6 or an aryl group having a carbon number of 6 to 10, and R³⁷ represents an alkyl group having a carbon number of 1 to 6 or an aryl group having a carbon number of 6 to 10.

R²⁷, R²⁸, R²⁹, R³¹ to R³⁷, R²¹ to R²³ in the case where a heterocycle is not formed, and R²¹ may be bonded to any other of them to form a 5-membered ring or a 6-membered ring. R³¹ and R³⁶, and R³¹ and R³⁷ may be directly bonded to each other.

R²¹ and R²² in the case where a heterocycle is not formed, each independently represents a hydrogen atom, an alkyl group or allyl group having a carbon number of 1 to 6 which may have a substituent, or an aryl group or aryl group having a carbon number of 6 to 11 which may have a substituent. R²³ and R²⁵ in the case where a heterocycle is not formed, each independently represents a hydrogen atom, a halogen atom, or an alkyl group or alkoxy group having a carbon number of 1 to 6.

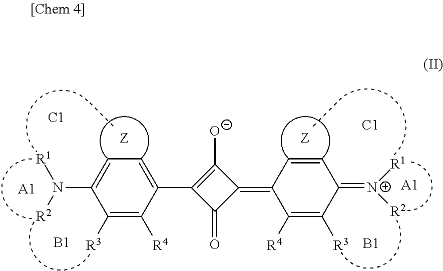

Here, symbols in Formula (II) are as follows.

Ring Z's each independently represents a 5-membered ring or 6-membered ring which has 0 to 3 heteroatoms in the ring and the hydrogen atom(s) contained in the ring Z may be substituted.

R¹ and R², R² and R³, and R¹ and a carbon atom or heteroatom constituting the ring Z may be boded to each other to form a heterocycle A1, a heterocycle B1 and a heterocycle C1 together with the nitrogen atom, respectively, and in that case, the hydrogen atom(s) contained in the heterocycle A1, the heterocycle B1 and the heterocycle C1 may be substituted. R¹ and R² in the case where the heterocycle is not formed, each independently represents a hydrogen atom, a halogen atom, or a hydrocarbon group which may contain an unsaturated bond, a heteroatom, or a saturated or unsaturated ring structure between carbon atoms, and may have a substituent. R⁴, and R³ in the case where the heterocycle is not formed, each independently represents a hydrogen atom, a halogen atom, or an alkyl group or alkoxy group which may contain a heteroatom between carbon atoms and may have a substituent.

<5> The optical filter according to any one of <1> to <4>, further including a transparent substrate, in which the absorption layer is provided on or above a main surface of the transparent substrate.

<6> The optical filter according to <5>, in which the transparent substrate is a glass or an absorption glass.

<7> The optical filter according to any one of <1> to <6>, in which the resin contains at least one selected from the group consisting of a polyimide resin, a polyamide resin, polyethylene naphthalate, a polyether sulfone, a polyether, an epoxy resin, and a cycloolefin resin.

<8> The optical filter according to any one of <1> to <7>, in which the resin contains a polyimide resin.

<9> The optical filter according to any one of <1> to <8>, in which the absorption layer further contains a silicon compound, and a content of the silicon compound in the absorption layer is 15% by mass or less.

<10> The optical filter according to any one of <1> to <9>, in which the absorption layer further contains a compound having a maximum absorption wavelength in 350 to 450 nm when spectral transmittance is measured after dissolving in dichloromethane.

<11> The optical filter according to any one of <1> to <10>, in which the absorption layer further contains a compound having a maximum absorption wavelength in 800 to 1,200 nm when spectral transmittance is measured after dissolving in dichloromethane.

<12> The optical filter according to any one of <1> to <11>, further including a reflection layer, in which the reflection layer satisfies all of the following characteristics (ii-1) to (ii-6) where IR50 represents a wavelength at a transmittance of 50% in a wavelength range of 600 to 800 nm and IR20 represents a wavelength at a transmittance of 20% in a wavelength range of 600 to 800 nm:

(ii-1) IR50 (IR50_{0deg}) at an incident angle of 0 degree is in a range of 680 to 800 nm;

(ii-2) IR20 (IR20_{0deg}) at an incident angle of 0 degree is in a range of 700 to 820 nm;

(ii-3) an absolute value of the difference between IR50 (IR50_{30deg}) at an incident angle of 30 degrees and IR50 (IR50_{0deg}) at an incident angle of 0 degree is 11 nm or more;

(ii-4) an average transmittance of light in a wavelength range of 435 to 500 nm is 88% or more;

(ii-5) an average transmittance of light in a wavelength range of 640 to 660 nm is 70% or more; and

(ii-6) an average transmittance of light in a wavelength range of 750 to 1,100 nm is 10% or less.

<13> The optical filter according to any one of <1> to <12>, satisfying all of the following characteristics (iii-1) to (iii-7) where IR50 represents a wavelength at a transmittance of 50% in a wavelength range of 600 to 800 nm, IR20 represents a wavelength at a transmittance of 20% in a wavelength range of 600 to 800 nm, and UV50 represents a wavelength at a transmittance of 50% in a wavelength range of 380 to 440 nm:

(iii-1) IR50 (IR50_{0deg}) at an incident angle of 0 degree is in a range of 640 to 760 nm;

(iii-2) IR20 (IR20_{0deg}) at an incident angle of 0 degree is in a range of 660 to 780 nm;

(iii-3) UV50 (UV50_{0deg}) at an incident angle of 0 degree is in a range of 390 to 430 nm;

(iii-4) an average transmittance of light in a wavelength range of 430 to 500 nm is 82% or more;

(iii-5) an average transmittance of light in a wavelength range of 640 to 660 nm is 65% or more;

(iii-6) a minimum transmittance of light in a wavelength range of 640 to 660 nm is 60% or more; and

(iii-7) an average transmittance of light in a wavelength range of 750 to 1,100 nm is 3% or less.

<14> The optical filter according to any one of <1> to <13>, satisfying the following characteristic (iii-8) where IR50 represents a wavelength at a transmittance of 50% in a wavelength range of 600 to 800 nm:

(iii-8) an absolute value of the difference between IR50 (IR50_{30deg}) at an incident angle of 30 degrees and IR50 (IR50_{0deg}) at an incident angle of 0 degree is 11 nm or less.

<15> The optical filter according to any one of <1> to <14>, satisfying the following characteristic (iii-9) where UV50 represents a wavelength at a transmittance of 50% in a wavelength range of 380 to 440 nm:

(iii-9) an absolute value of the difference between UV50 (UV50_{30deg}) at an incident angle of 30 degrees and UV50 (UV50_{0deg}) at an incident angle of 0 degree is 3 nm or less.

<16> An imaging apparatus including the optical filter described in any one of <1> to <15>.

### Advantageous Effects of Invention

According to the present invention, by using a squarylium dye having a high thermal decomposition temperature as a near-infrared absorbing dye and using a resin having a high glass transition temperature as a resin, an optical filter having excellent heat resistance can be obtained in which thermal deterioration and appearance abnormality are less likely to occur.

Furthermore, by using a squarylium dye whose transmittance changes steeply in a wavelength range of 600 to 800 nm, that is, near the boundary between near-infrared light and visible light, as the near-infrared absorbing dye, an optical filter having excellent light shielding properties of near-infrared light can be obtained.

### BRIEF DESCRIPTION OF DRAWINGS

FIG. 1 is a cross-sectional view schematically illustrating an embodiment of an optical filter according to the present invention.

FIG. 2 is a cross-sectional view schematically illustrating an embodiment of an optical filter according to the present invention.

FIG. 3 is a cross-sectional view schematically illustrating an embodiment of an optical filter according to the present invention.

FIG. 4 is a graph showing a spectral transmittance curve of the optical filter produced in Example 6-1.

FIG. 5 is a graph showing a spectral transmittance curve of the optical filter produced in Example 6-4.

### DESCRIPTION OF EMBODIMENTS

Hereinafter, embodiments of the present invention will be described.

In the present specification, a near-infrared absorbing dye may be abbreviated as “NIR dye” and the ultraviolet absorbing dye may be abbreviated as “UV dye”.

In the present specification, a compound represented by Formula (1) is referred to as compound (1) and the dye formed of the compound (I) is also referred to as a dye (I). The same applies to other formulae.

In the present specification, with respect to a specific wavelength range, the transmittance of 90% or more, for example, means that the transmittance does not fall below 90% in the entirety of the wavelength range, and similarly, the transmittance of 1% or less means that the transmittance does not exceed 1% in the entirety of the wavelength range. An average transmittance in a specific wavelength range is an arithmetic average of the transmittance per 1 nm in the wavelength range.

In the present specification, “to” representing a numerical range includes the upper and lower limits.

The optical filter of the present invention includes an absorption layer containing a near-infrared absorbing dye and a resin. Hereinafter, configuration examples of the optical filter of the present invention will be described with reference to the drawings.

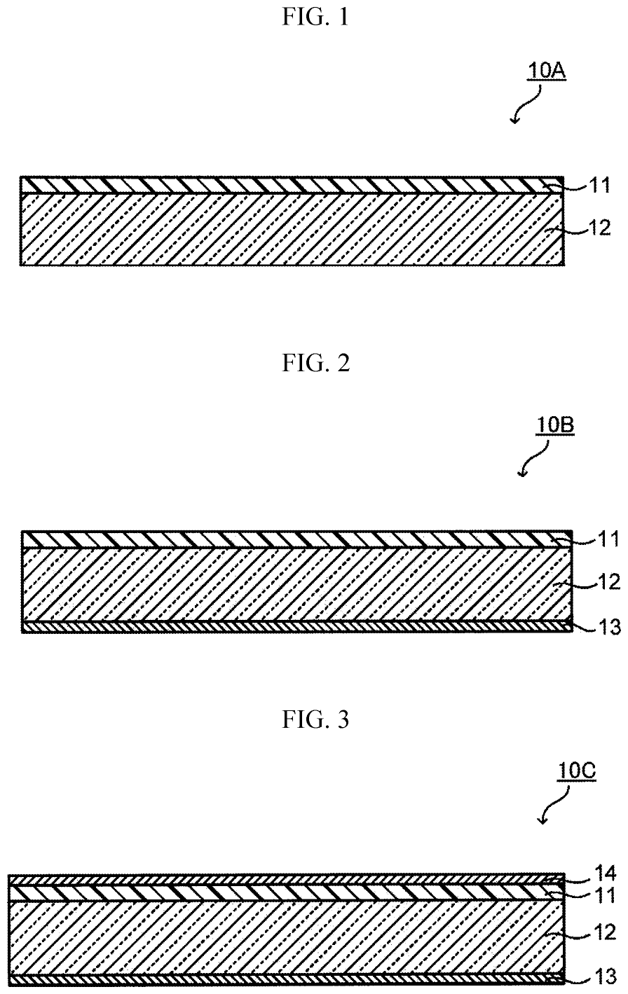

FIG. 1 is a cross-sectional view of an optical filter 10A having a transparent substrate 12 and an absorption layer 11 disposed on one main surface of the transparent substrate 12. The phrase “including the absorption layer 11 on one main surface of the transparent substrate 12” includes not only the case where the absorption layer 11 is provided in contact with the transparent substrate 12, but also the case where another functional layer is provided between the transparent substrate 12 and the absorption layer 11. The same applies to the configuration where a reflection layer 13 is provided on the other surface of the transparent substrate 12, which is to be mentioned later, and the same also applies to the following configuration.

Incidentally, in the case where the absorption layer itself functions as a substrate (transparent substrate), the transparent substrate 12 can be omitted.

FIG. 2 is a cross-sectional view of an optical filter 10B having a transparent substrate 12, an absorption layer 11 disposed on one main surface of the transparent substrate 12, and a reflection layer 13 provided on the other main surface of the transparent substrate 12.

FIG. 3 is a cross-sectional view of an optical filter 10C including an antireflection layer 14 on a main surface of the absorption layer 11. In the case where the absorption layer serves an outermost surface, it is preferable to provide an antireflection layer on the absorption layer. The antireflection layer may be configured to cover not only the outermost surface of the absorption layer but also the entire side surfaces of the absorption layer. As a result that the antireflection layer covers the side surface of the absorption layer to enhance an oxygen-barrier property, the light resistance of the dye in the absorption layer can be enhanced.

Hereinafter, the absorption layer, the reflection layer, the transparent substrate, and the antireflection layer will be described.

[Absorption Layer]

<Near-Infrared Absorbing Dye>

In the optical filter of the present invention, the near-infrared absorbing dye contains a squarylium dye.

The squarylium dye satisfies all of the following characteristics (i-1) to (i-3). The meanings of IR80 and IR20 are as follows.

IR80: wavelength at a transmittance of 80% in a wavelength range of 600 to 800 nm

IR20: wavelength at a transmittance of 20% in a wavelength range of 600 to 800 nm

(i-1) When spectral transmittance is measured after dissolving in dichloromethane, the squarylium dye has a maximum absorption wavelength in 650 to 780 nm. The dye has the maximum absorption wavelength in such a range and thus, can absorb light in a near-infrared region.

(i-2) The squarylium dye has a thermal decomposition temperature of 265° C. or higher, more preferably 280° C. or higher, and further preferably 300° C. or higher. Since the thermal decomposition temperature is in such a rage, the dye is not thermally deteriorated even when it is subjected to soldering by a reflow method, and an optical filter having excellent heat resistance can be obtained.

(i-3) The squarylium dye shows IR20−IR80<65 nm. IR20−IR80 is an index showing a change in transmittance in the wavelength range of 600 to 800 nm, that is, near the boundary between near-infrared light and visible light. The smaller the value, the steeper the spectral transmittance curve, and it means that the transmittance changes steeply. Considering the characteristics required for an optical filter that shields near-infrared light, it is ideal that the transmittance of visible light is 100% and the transmittance of near-infrared light is 0%. Therefore, smaller IR20−IR80 is more preferable.

The squarylium dye preferably further satisfies all of the following characteristics (i-4) to (i-6) in a spectral transmittance curve measured when the dye is dissolved in dichloromethane so that the transmittance at the maximum absorption wavelength is 10%.

(i-4) Since smaller IR20−IR80 is more preferable, the squarylium dye preferably shows IR20−IR80<60 nm.

(i-5) The squarylium dye preferably has an average transmittance of light in a wavelength range of 400 to 500 nm being 96% or more, and more preferably 97% or more.

(i-6) The squarylium dye preferably has a minimum transmittance of light in the wavelength range of 400 to 500 nm being 93% or more, and more preferably 94% or more.

In the case where the above-described characteristics are satisfied in 400 to 500 nm, that is, in a part of the so-called visible light region, a large amount of visible light can be taken in, and an optical filter having excellent color reproducibility can be obtained.

The squarylium dye preferably further satisfies all of the following characteristics (i-7) to (i-11) in a spectral transmittance curve measured when the dye is dissolved in the resin so that the transmittance at the maximum absorption wavelength is 10%.

The characteristics (i-7) to (i-11) define characteristics when the squarylium dye is actually contained in the absorption layer of the optical filter. Therefore, as the resin that dissolves the squarylium dye, the resin used for the absorption layer is preferable.

The spectral characteristics in the resin are measured after applying a solution containing the dye and the resin to a substrate. Here, in order to avoid the influence of reflection at the air interface and the substrate interface, the internal transmittance is evaluated.

Internal transmittance=(Measured transmittance/(100−Measured reflectance))×100

(i-7) The squarylium dye has a maximum absorption wavelength in a range of 650 to 790 nm. Since the squarylium dye has the maximum absorption wavelength in such a range, light in a near-infrared region can be absorbed.

(i-8) The squarylium dye has IR20 in a range of 630 to 770 nm. Since IR20 is in such a range, a large amount of visible light can be taken in and infrared light can be cut efficiently. Moreover, IR20 can be adjusted according to the infrared cut wavelength.

(i-9) The squarylium dye preferably shows IR20−IR80<80 nm, more preferably shows IR20−IR80<75 nm, and particularly preferably shows IR20−IR80<60 nm. Since IR20−IR80 is in such a range, even when actually contained in the absorption layer of the optical filter, the squarylium dye has a steep spectral characteristic in the near-infrared wavelength region.

(i-10) The squarylium dye preferably has an average transmittance of light in a wavelength range of 400 to 500 nm being 90% or more, and more preferably 94% or more.

(i-11) The squarylium dye preferably has a minimum transmittance of light in a wavelength range of 400 to 500 nm being 85% or more, and more preferably 92% or more.

When the above-described characteristics are satisfied in 400 to 500 nm, that is, in a part of the so-called visible light region, a large amount of visible light can be taken in, and an optical filter having excellent color reproducibility can be obtained.

As the squarylium dye, compounds represented by the following formula (I) or (II) are preferable.

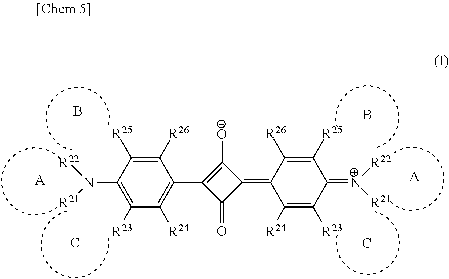

Here, symbols in Formula (I) are as follows.

R²⁴ and R²⁶ each independently represents a hydrogen atom, a halogen atom, a hydroxy group, an alkyl group or alkoxy group having a carbon number of 1 to 6, an acyloxy group having a carbon number of 1 to 10, —NR²⁷R²⁸ (R²⁷ and R²⁸ each independently represents a hydrogen atom, an alkyl group having a carbon number of 1 to 20, —C(═O)—R⁴⁹ (R²⁹ represents a hydrogen atom or a hydrocarbon group having a carbon number of 1 to 25 which may have a substituent and may contain an unsaturated bond, an oxygen atom, or a saturated or unsaturated ring structure between carbon atoms), —NHR³⁰, or —SO₂—R³⁰ (R³⁰ represents a hydrocarbon group having a carbon number of 1 to 25, each of which one or more hydrogen atoms may be substituted with a halogen atom, a hydroxy group, a carboxy group, a sulfo group, or a cyano group, and which may contain an unsaturated bond, an oxygen atom, or a saturated or unsaturated ring structure between carbon atoms)), or a group represented by the following Formula (S) (R⁴¹ and R⁴² each independently represents a hydrogen atom, a halogen atom, or an alkyl group or alkoxy group having a carbon number of 1 to 10, and k is 2 or 3).

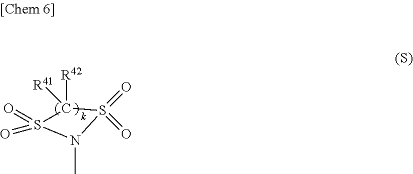

R²¹ and R²², R²² and R²⁵, and R²¹ and R²³ may be bonded to each other to form a heterocycle A, a heterocycle B, and a heterocycle C each having 5 or 6 members together with a nitrogen atom, respectively.

R²¹ and R²² in the case where the heterocycle A is formed represent, as a divalent group -Q- to which they are bonded, an alkylene group or alkyleneoxy group in which a hydrogen atom may be substituted with an alkyl group having a carbon number of 1 to 6, an aryl group having a carbon number of 6 to 10, or an acyloxy group having a carbon number of 1 to 10 which may have a substituent.

R²² and R²⁵ in the case where the heterocycle B is formed, and R²¹ and R²³ in the case where the heterocycle C is formed respectively represent, as divalent groups —X¹—Y¹— and —X²—Y²— (X¹ and X² are on the side that bonds to nitrogen) to which they are bonded, a group in which X¹ and X² are each a group represented by the following Formula (1x) or (2x), and Y¹ and Y² are each a group represented by any one selected from the following Formulae (1y) to (5y). In the case where X¹ and X² are each a group represented by the following Formula (2x), Y¹ and Y² may be a single bond, and in that case, an oxygen atom may be contained between carbon atoms.

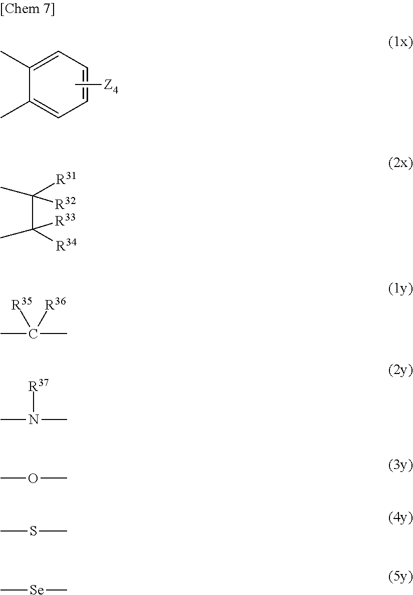

In Formula (1x), four Z's each independently represents a hydrogen atom, a hydroxy group, an alkyl group or alkoxy group having a carbon number of 1 to 6, or —NR³⁸R³⁹ (R³⁸ and R³⁹ each independently represents a hydrogen atom or an alkyl group having a carbon number of 1 to 20). R³¹ to R³⁶ each independently represents a hydrogen atom, an alkyl group having a carbon number of 1 to 6 or an aryl group having a carbon number of 6 to 10, and R³⁷ represents an alkyl group having a carbon number of 1 to 6 or an aryl group having a carbon number of 6 to 10.

R²⁷, R²⁸, R²⁹, R³¹ to R³⁷, R²¹ to R²³ in the case where a heterocycle is not formed, and R²⁵ may be bonded to any other of them to form a 5-membered ring or a 6-membered ring. R³¹ and R³⁶, and R³¹ and R³⁷ may be directly bonded to each other.

R²¹ and R²² in the case where a heterocycle is not formed, each independently represents a hydrogen atom, an alkyl group or allyl group having a carbon number of 1 to 6 which may have a substituent, or an aryl group or araryl group having a carbon number of 6 to 11 which may have a substituent. R³ and R^{2S} in the case where a heterocycle is not formed, each independently represents a hydrogen atom, a halogen atom, or an alkyl group or alkoxy group having a carbon number of 1 to 6.

In Formula (I), unless otherwise state, the hydrocarbon group is an alkyl group, an aryl group, or an araryl group. Unless otherwise stated, the alkyl moiety in the alkyl group, the alkoxy group, the aryl group, or the araryl group may be linear, branched, cyclic, or a structure to be formed by combining these structures. The same applies to the hydrocarbon group, the alkyl group, the alkoxy group, the aryl group, and the araryl group in the following other formulae.

In Formula (I), examples of the substituent in R²⁹ include a halogen atom, a hydroxy group, a carboxy group, a sulfo group, a cyano group, and an acyloxy group having a carbon number of 1 to 6. Examples of the substituent in the case of “may have a substituent” except R²⁹ include a halogen atom or an alkoxy group having a carbon number of 1 to 15. The halogen atom includes a fluorine atom, a chlorine atom, a bromine atom, an iodine atom, and the like, and a fluorine atom and a chlorine atom are preferable.

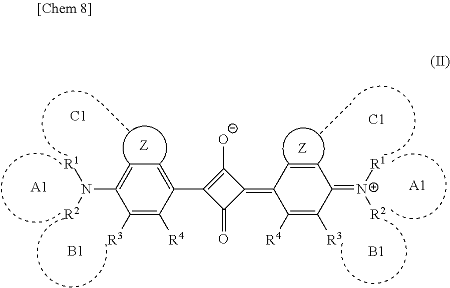

Here, symbols in Formula (II) are as follows.

Ring Z's each independently represents a 5-membered ring or 6-membered ring which has 0 to 3 heteroatoms in the ring and the hydrogen atom(s) of the ring Z may be substituted.

R¹ and R², R² and R³, and R¹ and the carbon atom or heteroatom constituting the ring Z may be boded to each other to form a heterocycle A1, a heterocycle B1 and a heterocycle C1 together with a nitrogen atom, respectively, and in that case, the hydrogen atom(s) of the heterocycle A1, the heterocycle B1 and the heterocycle C1 may be substituted. In the case where the hydrogen atom is substituted, examples of the substituent includes a halogen atom or an alkyl group having a carbon number of 1 to 15 which may have a substituent.

R¹ and R² in the case where the heterocycle is not formed, each independently represents a hydrogen atom, a halogen atom, or a hydrocarbon group which may contain an unsaturated bond, a heteroatom, or a saturated or unsaturated ring structure between carbon atoms, and may have a substituent. R⁴, and R³ in the case where the heterocycle is not formed, each independently represents a hydrogen atom, a halogen atom, or an alkyl group or alkoxy group which may contain a heteroatom between carbon atoms and may have a substituent.

In Formula (II), the hydrocarbon group may have a carbon number of 1 to 15. The alkyl group or alkoxy group may have a carbon number of 1 to 10. In Formula (II), examples of the substituent in the case of “may have a substituent” include a halogen atom or an alkoxy group having a carbon number of 1 to 10. The halogen atom includes a fluorine atom, a chlorine atom, a bromine atom, an iodine atom, and the like, and a fluorine atom and a chlorine atom are preferable.

Examples of the compound (I) include compounds represented by Formula (I-1). When benzene rings are bonded to both sides of the squarylium skeleton and further the benzene ring forms a five-membered condensed ring, the structure is stabilized and a dye having excellent heat resistance can be formed.

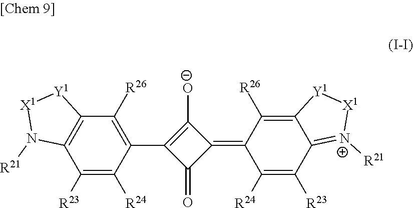

Here, the symbols in Formula (I-1) are the same as the respective definitions of the same symbols in Formula (I), and the preferable embodiments are also the same.

In the compound (I-1), X¹ is preferably the group (2x), and Y¹ is preferably a single bond or the group (1y). In this case, R³¹ to R³⁶ are preferably a hydrogen atom or an alkyl group having a carbon number of 1 to 3, and more preferably a hydrogen atom or a methyl group. Specific examples of —Y¹—X¹— include divalent organic groups represented by Formulae (11-1) to (12-3).

—C(CH₃)₂—CH(CH₃)— (11-1)

—C(CH₃)₂—CH₂— (11-2)

—C(CH₃)₂—CH(C₂H₅)— (11-3)

—C(CH₃)₂—C(CH₃)(nC₃H₇)— (11-4)

—C(CH₃)₂—CH₂—CH₂— (12-1)

—C(CH₃)₂—CH₂—CH(CH₃)— (12-2)

—C(CH₃)₂—CH(CH₃)—CH₂— (12-3)

Furthermore, in the compound (I-1), R²¹ is independently more preferably a group represented by Formula (4-1) or (4-2) from the viewpoint of solubility, heat resistance, and steepness of change near the boundary between the visible region and the near-infrared region in the spectral transmittance curve.

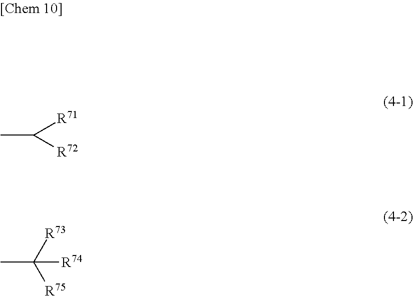

In Formulae (4-1) and (4-2), R⁷¹ to R⁷⁵ each independently represents a hydrogen atom, a halogen atom, or an alkyl group having a carbon number of 1 to 4.

In the compound (1-1), R²⁴ is preferably —NR²⁷R²⁸.

As —NR²⁷R²⁸, —NH—C(═O)—R²⁹ is preferable from the viewpoint of the solubility in a resin or a solvent (hereinafter, also referred to as “host solvent”) used when forming an absorption layer. Since the oxygen atom of the squarylium skeleton and the hydrogen atom in R²⁴ forms a hydrogen bond, the stability of the compound enhances and thus a dye having excellent heat resistance can be obtained.

Compounds in which R²⁴ is —NH—C(═O)—R²⁹ in the compounds (I-1) are represented by Formula (I-11).

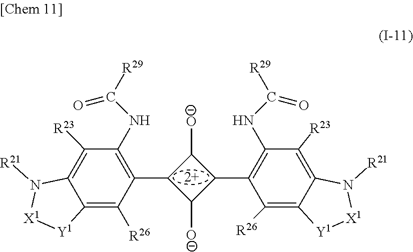

R²³ and R²⁶ in the compound (I-11) each independently preferably represents a hydrogen atom, a halogen atom, or an alkyl group or alkoxy group having a carbon number of 1 to 6, and each more preferably a hydrogen atom.

In the compound (I-11), R²⁹ is preferably an alkyl group having a carbon number of 1 to 20 which may have a substituent and may have an oxygen atom between carbon atoms, an aryl group having a carbon number of 6 to 10 which may have a substituent, or an araryl group having a carbon number of 7 to 18 which may have a substituent and may have an oxygen atom between carbon atoms. Examples of the substituents include a hydroxy group, a carboxy group, a sulfo group, a cyano group, an alkyl group having a carbon number of 1 to 6, a fluoroalkyl group having a carbon number of 1 to 6, an alkoxy group having a carbon number of 1 to 6, an acyloxy group having a carbon number of 1 to 6, and the like.

R²⁹ is, from the viewpoint of heat resistance preferably a linear, branched or cyclic alkyl group having a carbon number of 1 to 17 which may have an oxygen atom between carbon atoms or an aryl group having a carbon number of 6 to 10 which may have a substituent.

More specific examples of the compound (I-li) include the compounds indicated in the following table. Furthermore, in the compounds indicated in the following table, each symbol has the same meaning on the left and right of the squarylium skeleton.

TABLE 1

| | Substituent | | | | |
|---|---|---|---|---|---|
| Abbreviated dye code | —Y¹—X¹— | R²¹ | R²⁹ | R²³ | R²⁶ |
| (I-11-1) | —C(CH₃)₂—C(CH₃)(nC₃H₇)— | —CH(CH₃)₂ | —CH(C₂H₅)(nC₄H₉) | H | H |
| (I-11-2) | —C(CH₃)₂—C(CH₃)(C₂H₅)— | —CH(CH₃)₂ | —nC₇H₁₅ | H | H |
| (I-11-3) | —C(CH₃)₂—CH(CH₃)— | —CH(CH₃)₂ | —CH(C₂H₅)(nC₄H₉) | H | H |
| (I-11-4) | —C(CH₃)₂—CH(CH₃)— | —CH(CH₃)₂ | —CH(C₂H₅)(nC₄H₉) | H | H |
| (I-11-5) | —C(CH₃)₂—C(CH₃)(nC₃H₇)— | —CH(CH₃)₂ | —CH₃ | H | H |
| (I-11-6) | —C(CH₃)₂—C(CH₃)(nC₃H₇)— | —CH(CH₃)₂ | —nC₃H₇ | H | H |
| (I-11-7) | —C(CH₃)₂—C(CH₃)(nC₃H₇)— | —CH(CH₃)₂ | —nC₅H₁₁ | H | H |
| (I-11-8) | —C(CH₃)₂—C(CH₃)(nC₃H₇)— | —CH(CH₃)₂ | —C(CH₃)₂(nC₃H₇) | H | H |
| (1-11-9) | —C(CH₃)₂—C(CH₃)(nC₃H₇)— | —CH(CH₃)₂ | —C(CH₃)₂(nC₄H₉) | H | H |
| (I-11-10) | —C(CH₃)₂—C(CH₃)(nC₃H₇)— | —CH₃ | —CH₃ | H | H |
| (I-11-11) | —C(CH₃)₂—C(CH₃)(nC₃H₇)— | —CH₃ | —nC₃H₇ | H | H |
| (I-11-12) | —C(CH₃)₂—C(CH₃)(nC₃H₇)— | —CH₃ | —nC₅H₁₁ | H | H |
| (I-11-13) | —C(CH₃)₂—C(CH₃)(nC₃H₇)— | —CH₃ | —C(CH₃)₂(nC₃H₇) | H | H |
| (I-11-14) | —C(CH₃)₂—C(CH₃)(nC₃H₇)— | —CH₃ | —C(CH₃)₂(nC₄H₉) | H | H |
| (I-11-15) | —C(CH₃)₂—C(CH₃)(nC₃H₇)— | —CH₃ | —CH(C₂H₅)(nC₄H₉) | H | H |
| (I-11-16) | —C(CH₃)₂—C(CH₃)(nC₃H₇)— | —CH₃ | —nCH₁₇H₃₅ | H | H |
| (I-11-17) | —C(CH₃)₂—C(CH₃)(nC₃H₇)— | —C₂H₅ | —CH₃ | H | H |
| (1-11-18) | —C(CH₃)₂—C(CH₃)(nC₃H₇)— | —C₂H₅ | —nC₃H₇ | H | H |
| (I-11-19) | —C(CH₃)₂—C(CH₃)(nC₃H₇)— | —C₂H₅ | —nC₅H₁₁ | H | H |
| (I-11-20) | —C(CH₃)₂—C(CH₃)(nC₃H₇)— | —C₂H₅ | —C(CH₃)₂(nC₃H₇) | H | H |
| (I-11-21) | —C(CH₃)₂—C(CH₃)(nC₃H₇)— | —C₂H₅ | —C(CH₃)₂(nC₄H₉) | H | H |
| (1-11-22) | —C(CH₃)₂—C(CH₃)(nC₃H₇)— | —C₂H₅ | —CH(C₂H₅)(nC₄H₉) | H | H |
| (I-11-23) | —C(CH₃)₂—C(CH₃)(nC₃H₇)— | —C₂H₅ | —nCH₁₇H₃₅ | H | H |
| (1-11-24) | —C(CH₃)₂—C(CH₃)(nC₃H₇)— | —nC₃H₇ | —CH₃ | H | H |
| (1-11-25) | —C(CH₃)₂—C(CH₃)(nC₃H₇)— | —nC₃H₇ | —nC₃H₇ | H | H |
| (1-11-26) | —C(CH₃)₂—C(CH₃)(nC₃H₇)— | —nC₃H₇ | —nC₅H₁₁ | H | H |
| (1-11-27) | —C(CH₃)₂—C(CH₃)(nC₃H₇)— | —nC₃H₇ | —C(CH₃)₂(nC₃H₇) | H | H |
| (1-11-28) | —C(CH₃)₂—C(CH₃)(nC₃H₇)— | —nC₃H₇ | —C(CH₃)₂(nC₄H₉) | H | H |
| (I-11-29) | —C(CH₃)₂—C(CH₃)(nC₃H₇)— | —nC₃H₇ | —CH(C₂H₅)(nC₄H₉) | H | H |
| (I-11-30) | —C(CH₃)₂—C(CH₃)(nC₃H₇)— | —nC₃H₇ | —nCH₁₇H₃₅ | H | H |

In the compound (I-1), R²⁴ is preferably —NH—SO₂—R³⁰ from the viewpoint of increasing the transmittance of visible light, particularly the transmittance of light having a wavelength of 430 to 550 nm. Compounds in which R²⁴ is —NH—SO₂—R³⁰ in the compound (I-1) are represented by Formula (I-12).

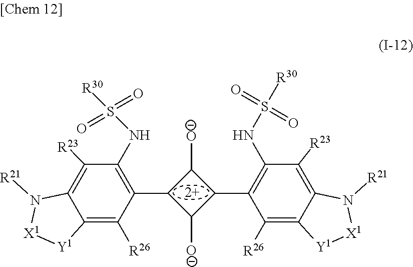

R²³ and R²⁶ in the compound (I-12) each independently preferably represents a hydrogen atom, a halogen atom, or an alkyl group or alkoxy group having a carbon number of 1 to 6, and more preferably a hydrogen atom.

In the compound (I-12), R³⁰ is independently preferably a linear, branched or cyclic alkyl group having a carbon number of 1 to 17 which may have an oxygen atom between carbon atoms or an aryl group having a carbon number of 6 to 10 which may have a substituent, from the viewpoint of heat resistance.

More specific examples of the compound (I-12) include the compounds indicated in the following table. Furthermore, in the compounds indicated in the following table, each symbol has the same meaning on the left and right of the squarylium skeleton.

TABLE 2

| | Substituent | | | | |
|---|---|---|---|---|---|
| Abbreviated dye code | —Y¹—X¹— | R²¹ | R³⁰ | R²³ | R²⁶ |
| (I-12-1) | —C(CH₃)₂—C(CH₃)(nC₃H₇)— | —CH(CH₃)₂ | —nC₄H₉ | H | H |
| (1-12-2) | —C(CH₃)₂—C(CH₃)(nC₃H₇)— | —CH(CH₃)₂ | —nC₈H₁₇ | H | H |
| (I-12-3) | —C(CH₃)₂—C(CH₃)(nC₃H₇)— | —CH(CH₃)₂ | —CH₃ | H | H |
| (1-12-4) | —C(CH₃)₂—C(CH₃)(nC₃H₇)— | —CH(CH₃)₂ | —nC₃H₇ | H | H |
| (1-12-5) | —C(CH₃)₂—C(CH₃)(nC₃H₇)— | —CH(CH₃)₂ | Ph—C3 | H | H |
| (1-12-6) | —C(CH₃)₂—C(CH₃)(nC₃H₇)— | —CH(CH₃)₂ | Ph—C5 | H | H |
| (1-12-7) | —C(CH₃)₂—C(CH₃)(nC₃H₇)— | —CH₃ | —nC₄H₉ | H | H |
| (1-12-8) | —C(CH₃)₂—C(CH₃)(nC₃H₇)— | —CH₃ | —nC₈H₁₇ | H | H |
| (1-12-9) | —C(CH₃)₂—C(CH₃)(nC₃H₇)— | —CH₃ | —CH₃ | H | H |
| (I-12-10) | —C(CH₃)₂—C(CH₃)(nC₃H₇)— | —CH₃ | —nC₃H₇ | H | H |
| (I-12-11) | —C(CH₃)₂—C(CH₃)(nC₃H₇)— | —CH₃ | Ph—C3 | H | H |
| (1-12-12) | —C(CH₃)₂—C(CH₃)(nC₃H₇)— | —CH₃ | Ph—C5 | H | H |
| (I-12-13) | —C(CH₃)₂—C(CH₃)(nC₃H₇)— | —C₂H₅ | —nC₄H₉ | H | H |
| (1-12-14) | —C(CH₃)₂—C(CH₃)(nC₃H₇)— | —C₂H₅ | —nC₈H₁₇ | H | H |
| (1-12-15) | —C(CH₃)₂—C(CH₃)(nC₃H₇)— | —C₂H₅ | —CH₃ | H | H |
| (1-12-16) | —C(CH₃)₂—C(CH₃)(nC₃H₇)— | —C₂H₅ | —nC₃H₇ | H | H |
| (1-12-17) | —C(CH₃)₂—C(CH₃)(nC₃H₇)— | —C₂H₅ | Ph—C3 | H | H |
| (1-12-18) | —C(CH₃)₂—C(CH₃)(nC₃H₇)— | —C₂H₅ | Ph—C5 | H | H |
| (1-12-19) | —C(CH₃)₂—C(CH₃)(nC₃H₇)— | —nC₃H₇ | —nC₄H₉ | H | H |
| (1-12-20) | —C(CH₃)₂—C(CH₃)(nC₃H₇)— | —nC₃H₇ | —nC₈H₁₇ | H | H |
| (1-12-21) | —C(CH₃)₂—C(CH₃)(nC₃H₇)— | —nC₃H₇ | —CH₃ | H | H |
| (1-12-22) | —C(CH₃)₂—C(CH₃)(nC₃H₇)— | —nC₃H₇ | —nC₃H₇ | H | H |
| (1-12-23) | —C(CH₃)₂—C(CH₃)(nC₃H₇)— | —nC₃H₇ | Ph—C3 | H | H |
| (1-12-24) | —C(CH₃)₂—C(CH₃)(nC₃H₇)— | —nC₃H₇ | Ph—C5 | H | H |
| (1-12-25) | —C(CH₃)₂—CH(CH₃)— | —CH(CH₃)₂ | —nC₈H₁₇ | H | H |
| (1-12-26) | —C(CH₃)₂—CH(CH₃)— | —CH(CH₃)₂ | —nC₄H₉ | H | H |
| (1-12-27) | —C(CH₃)₂—CH(CH₃)— | —CH₃ | —nC₈H₁₇ | H | H |
| (1-12-28) | —C(CH₃)₂—CH(CH₃)— | —CH₃ | —nC₄H₉ | H | H |
| (1-12-29) | —C(CH₃)₂—CH(CH₃)— | —C₂H₅ | —nC₈H₁₇ | H | H |
| (I-12-30) | —C(CH₃)₂—CH(CH₃)— | —C₂H₅ | —nC₄H₉ | H | H |

In the above table, Ph-C3 and Ph-C5 are structures shown below, respectively.

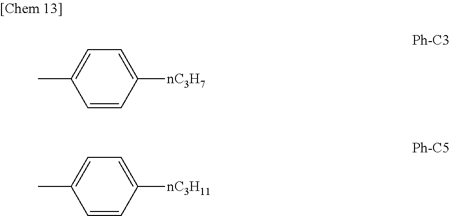

Examples of the compound (II) include compounds represented by Formula (II-3).

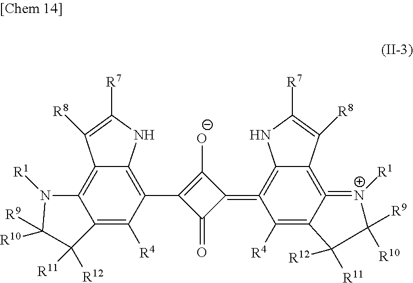

In Formula (II-3), R¹, R⁴, and R⁹ to R² each independently represents a hydrogen atom, a halogen atom, or an alkyl group having a carbon number of 1 to 15 which may have a substituent, and R⁷ and R⁸ each independently represents a hydrogen atom, a halogen atom, or an alkyl group having a carbon number of 1 to 5 which may have a substituent.

R¹ is independently preferably an alkyl group having a carbon number of 1 to 15, more preferably an alkyl group having a carbon number of 1 to 10, and particularly preferably an ethyl group or an isopropyl group, from the viewpoint of solubility in a resin, visible light transmittance, and the like.

R is independently preferably a hydrogen atom or a halogen atom, and particularly preferably a hydrogen atom, from the viewpoint of visible light transmittance and ease of synthesis.

R⁷ and R⁸ each independently preferably represents a hydrogen atom, a halogen atom, or an alkyl group having a carbon number of 1 to 5 which may be substituted with a halogen atom, and more preferably a hydrogen atom, a halogen atom, or a methyl group.

R⁹ to R¹² each independently preferably represents a hydrogen atom, a halogen atom, or an alkyl group having a carbon number of 1 to 5 which may be substituted with a halogen atom.

Examples of —CR⁹R¹⁰—CR¹¹R¹²— include a divalent organic group represented by the following groups (13-1) to (13-5).

—CH(CH₃)—C(CH₃)₂— (13-1)

—C(CH₃)₂—CH(CH₃)— (13-2)

—C(CH₃)₂—CH₂— (13-3)

—C(CH₃)₂—CH(C₂H₅)— (13-4)

—C(CH₃)(CH₂—CH(CH₃)₂)—CH(CH₃)— (13-5)

More specific examples of the compound (II-3) include the compounds indicated in the following table. Furthermore, in the compounds indicated in the following table, each symbol has the same meaning on the left and right of the squarylium skeleton.

TABLE 3

| | Substituent | | | | |
|---|---|---|---|---|---|
| Abbreviated dye code | —CR⁹R¹⁰—CR¹¹R^{12—} | R¹ | R⁴ | R⁷ | R⁸ |
| (II-3-1) | —CH(CH₃)—C(CH₃)(CH₂CH(CH₃)₂)— | —C₂H₅ | H | H | H |
| (II-3-2) | —CH(CH₃)—C(CH₃)(CH₂CH(CH₃)₂)— | —CH₃ | H | H | H |
| (II-3-3) | —CH(CH₃)—C(CH₃)(CH₂CH(CH₃)₂)— | —nC₃H₇ | H | H | H |
| (II-3-4) | —CH(CH₃)—C(CH₃)(CH₂CH(CH₃)₂)— | —CH(CH₃)₂ | H | H | H |
| (II-3-5) | —CH(CH₃)—C(CH₃)₂— | —CH₃ | H | H | H |
| (II-3-6) | —CH(CH₃)—C(CH₃)₂— | —nC₃H₇ | H | H | H |
| (II-3-7) | —CH(CH₃)—C(CH₃)₂— | —CH(CH₃)₂ | H | H | H |

As the dye (I) and the dye (II), one kind thereof may be used or two or more kinds thereof may be mixed and used.

The content of the NIR dye in the absorption layer is appropriately selected depending on the design of the optical filter, for example, so as to satisfy the characteristics of (ii-1) to (ii-6) in relation to the reflection layer to be described later and the characteristics of (iii-1) to (iii-9) as the optical filter to be described later. The content of the NIR dye in the absorption layer is preferably 0.01 to 20 parts by mass based on 100 parts by mass of the resin from the viewpoint of ensuring the transmittance of visible light, especially blue light, shielding near-infrared light, and not excessively lowering the glass transition temperature (Tg) of the entire resin.

<Other Dyes>

The absorption layer may further contain other dyes other than the near-infrared absorbing dyes in the range where the effects of the present invention are not impaired. Examples of the other dyes include ultraviolet absorbing dyes and infrared absorbing dyes having a maximum absorption wavelength at 800 to 1,200 nm.

As the ultraviolet absorbing dye (UV dye), a compound having a maximum absorption wavelength at 350 to 450 nm when spectral transmittance is measured after dissolving in dichloromethane is preferable. In the case where the absorption layer contains an ultraviolet absorbing dye, the oblique-incident characteristics on the UV side can be improved.

Specific examples of the UV dyes include oxazole dyes, merocyanine dyes, cyanine dyes, naphthalimide dyes, oxadiazole dyes, oxazine dyes, oxazolidine dyes, naphthalic acid dyes, styryl dyes, anthracene dyes, cyclic carbonyl dyes, triazole dyes, and the like. Among them, an oxazole dye or a merocyanine dye is preferable. Furthermore, the UV dye may be used alone or two or more kinds thereof may be used in combination in the absorption layer.

The content of the UV dye in the absorption layer is preferably 0.01 to 20% by mass from the viewpoint of not excessively lowering Tg of the absorption layer.

As the infrared absorbing dye having a maximum absorption wavelength at 800 to 1,200 nm, a compound having a maximum absorption wavelength at 800 to 1,200 nm when spectral transmittance is measured after dissolving in dichloromethane is preferable. In the case where the absorption layer contains such an infrared absorbing dye, light in the wavelength range of 800 to 1,200 nm can be also reduced by absorption, and flare and ghost can be suppressed.

Specific examples of such an infrared absorbing dye include dyes having an absorption at 800 to 1,200 nm, such as squarylium dyes, phthalocyanine dyes, cyanine dyes, and diketopyrrolopyrrole dyes. Among them, a squarylium dye having excellent visible light transmittance is preferable from the viewpoint of efficiently cutting light in a desired wavelength region by absorption and maintaining a high visible light transmittance. Furthermore, as the infrared absorbing dye, one kind may be used alone, or two or more kinds may be used in combination in the absorption layer.

The content of the infrared absorbing dye in the absorption layer is preferably 0.01 to 20% by mass from the viewpoint of not excessively lowering Tg of the entire resin.

<Resin>

The resin used for the absorption layer has a glass transition temperature (Tg) of 390° C. or higher, and preferably 400° C. or higher. Since the glass transition temperature of the resin is in such a range, such appearance abnormality that the resin is thermally decomposed to generate bubbles and adhesiveness to the transparent substrate is lowered is unlikely to occur even when soldering is performed by the reflow method, and thus an optical filter having excellent heat resistance can be obtained. Furthermore, even when the NIR dye has a high thermal decomposition temperature and excellent in heat resistance, in the case where the glass transition temperature of the resin is low, thermal collision is likely to occur and the thermal decomposition of the dye may be promoted. Therefore, it is important that the glass transition temperature of the resin is high in order to obtain an optical filter having excellent heat resistance.

Examples of the resin include polyimide resins, polyamide resins, polyethylene naphthalate, polyether sulfones, polyethers, epoxy resins, cycloolefin resins, and the like. Among them, a polyimide resin is preferable from the viewpoint of particularly high glass transition temperature. One kind of these resins may be used alone, or two or more kinds thereof may be mixed and used.

In addition, the resin preferably transmits light having a wavelength of 400 to 900 nm, that is, visible light.

<Silicon Compound>

The absorption layer preferably further contains a silicon compound. In the case where the absorption layer contains a silicon compound, the adhesiveness between the transparent substrate and the absorption layer can be improved

In the case where the amount of the silicon compound to be blended is too large, the heat resistance of the resin is lowered and at the time of forming the absorption layer, volatilization occurs to form bubbles, which may cause poor appearance. From this viewpoint, the content of the silicon compound in the absorption layer is preferably 15% by mass or less, and more preferably 10% by mass or less.

Specific examples of the silicon compound include silane coupling agents having a functional group such as an epoxy group, an amino group, a methacrylic group, an acrylic group, and a ureido group, and the like. Among them, a silane coupling agent containing an epoxy group is preferable from the viewpoint of not deteriorating the dye and from the viewpoint of the adhesiveness to a base material or to a dielectric multilayer film. Furthermore, as the silicon compound, one kind may be used alone, or two or more kinds may be used in combination in the absorption layer.

Within a range where the effects of the present invention are not impaired, the absorption layer may further contain optional components, such as an adhesion promoter, a color tone compensation dye, a leveling agent, an antistatic agent, a heat stabilizer, a light stabilizer, an antioxidant, a dispersant, a flame retardant, a lubricant, and a plasticizer.

In the optical filter of the present invention, the absorption layer preferably has a thickness of 0.1 to 100 μm. In the case where the absorption layer is formed of a plurality of layers, the total thickness of each layer is preferably 0.1 to 100 μm. In the case where the thickness is less than 0.1 μm, the desired optical properties may not be sufficiently exhibited. In the case where the thickness exceeds 100 μm, the flatness of the absorption layer may be deteriorated and the in-plane variation of the absorptance may occur. The thickness of the absorption layer is more preferably 0.3 to 50 μm. In addition, in the case where the optical filter of the present invention includes other functional layers such as a reflection layer and an antireflection layer, when the absorption layer is excessively thick, cracks or the like may occur depending on the material. Therefore, the thickness of the absorption layer is more preferably 0.3 to 10 μm.

The absorption layer can be formed, for example, in such a manner that the NIR dye, the resin or a raw material component of the resin, and each component to be blended as necessary are dissolved or dispersed in a solvent to prepare a coating liquid, and the coating liquid is applied to a base material, dried, and cured as necessary. The base material may be a transparent substrate included in the optical filter of the present invention or a peelable base material used only at the time of forming the absorption layer. The solvent may be any dispersion medium in which the dye can be stably dispersed or any solvent in which the dye can be dissolved.

In addition, the coating liquid may contain a surfactant for the purpose of improving voids caused by minute bubbles, recesses caused by adhesion of foreign substances or the like, repellency during a drying step, and the like. Furthermore, for applying the coating liquid, for example, a dip coating method, a cast coating method, a spin coating method, or the like can be used. The coating liquid is applied onto the base material and then dried to form the absorption layer. In the case where the coating liquid contains the raw material component of the transparent resin, a curing treatment such as heat curing or photocuring is further performed.

The absorption layer can also be produced in a film shape by extrusion molding, and this film may be laminated on another member and integrated by thermocompression bonding or the like. For example, in the case where the optical filter includes a transparent substrate, this film may be attached on the transparent substrate.

One layer or two or more layers of the absorption layers may be included in the optical filter. In the case where the optical filter includes two or more layers of the absorption layers, the layers may have the same structure or different structures from each other. As an example, one layer may be a near-infrared absorption layer containing the NIR dye and a resin, and the other layer may be a near-ultraviolet absorption layer containing the UV dye and the resin.

Furthermore, the absorption layer may itself function as a substrate (transparent substrate).

[Transparent Substrate]

The transparent substrate is not particularly limited in its constituent material as long as it transmits visible light of approximately 400 to 700 nm, and may be a material that absorbs near-infrared light or near-ultraviolet light. Examples thereof include inorganic materials such as glass and a crystal, and organic materials such as a transparent resin. The absorption layer itself may also function as a transparent substrate, but from the viewpoint of being resistant to thermal deformation at a high temperature during reflow method, the absorption layer may be provided on or above the main surface of the transparent substrate, and the transparent substrate may be glass or absorption glass.

Examples of the glass that can be used as the transparent substrate include absorptive glass (near-infrared absorption glass) where fluorophosphate glass or phosphate glass contains copper ions, soda lime glass, borosilicate glass, alkali-free glass, quartz glass, and the like. As the glass, an absorption glass is preferable depending on the purpose, and a phosphate glass or a fluorophosphate glass is preferable from the viewpoint of absorbing infrared light. In the case where it is desired to take in a large amount of red light (600 to 700 nm), an alkaline glass, an alkali-free glass, and a quartz glass are preferable. The “phosphate glass” also includes a silicophosphate glass in which a part of the glass skeleton is made of SiO₂.

As the glass, use can be made of a chemically strengthened glass obtained by exchanging alkali metal ions (e.g., Li ion and Na ion) having a small ionic radius existing on the main surface of the glass plate with alkali ions (e.g., Na ion or K ion for Li ion, and K ion for Na ion) having a larger ionic radius by ion exchange at a temperature not higher than the glass transition point.

Examples of the transparent resin material that can be used as the transparent substrate include polyester resins such as polyethylene terephthalate and polybutylene terephthalate, polyolefin resins such as polyethylene, polypropylene and ethylene vinyl acetate copolymers, norbornene resins, acrylic resins such as polyacrylate and poly(methyl methacrylate), urethane resins, vinyl chloride resins, fluororesins, polycarbonate resins, polyvinyl butyral resins, polyvinyl alcohol resins, polyimide resins, and the like.

In addition, examples of the crystal material that can be used as the transparent substrate include birefringent crystals such as quartz, lithium niobate and sapphire. As for the optical characteristics of the transparent substrate, it is preferable to achieve the above-mentioned optical characteristics when an optical filter is obtained by laminating with the absorption layer, the reflection layer and the like. Sapphire is preferable as the crystal material.

The transparent substrate is preferably an inorganic material, and particularly preferably glass or sapphire, from the viewpoint of shape stability related to long-term reliability of optical characteristics, mechanical characteristics and the like as an optical filter, from the viewpoint of handleability during filter manufacturing, and the like.

The shape of the transparent substrate is not particularly limited, and may be a block shape, a plate shape or a film shape, and the thickness thereof is preferably, for example, 0.03 to 5 mm, and is more preferably 0.03 to 0.5 mm from the viewpoint of thinning. From the viewpoint of workability, a transparent substrate formed of a plate-shaped glass and having a plate thickness of 0.05 to 0.5 mm is preferable.

[Reflection Layer]

The optical filter of the present invention preferably further includes a reflection layer.

The reflection layer is formed of a dielectric multilayer film and has a function of shielding light in a specific wavelength region. Examples of the reflection layer include those having wavelength selectivity that transmits visible light and mainly reflects light having a wavelength other than the light-shielding region of the absorption layer. The reflection layer preferably has a reflection region that reflects near-infrared light. In this case, the reflection region of the reflection layer may include a light-shielding region in the near-infrared region of the absorption layer. The reflection layer is not limited to the above-mentioned characteristics, and may be appropriately designed to have a specification that further shields light in a predetermined wavelength region, for example, near ultraviolet region.

The reflection layer is formed of a dielectric multilayer film in which a dielectric film having a low refractive index (low-refractive index film) and a dielectric film having a high refractive index (high-refractive index film) are alternately laminated. The high-refractive index film preferably has a refractive index of 1.6 or more, and more preferably 2.2 to 2.5. Examples of the material of the high-refractive index film include Ta₂O₅, TiO₂ and Nb₂O₅. Among them, TiO₂ is preferable from the viewpoints of film formability, reproducibility in refractive index or the like, stability, and the like.

On the other hand, the low-refractive index film preferably has a refractive index of less than 1.6, and more preferably 1.45 or more and less than 1.55. Examples of the material of the low-refractive index film include SiO₂, SiOₓN_{y} and the like. From the viewpoints of reproducibility in film formability, stability, economy, and the like, SiO₂ is preferable.

The reflection layer preferably satisfies all of the following characteristics (ii-1) to (ii-6). Here, the meanings of IR50 and IR20 are as follows.

IR50: wavelength at a transmittance of 50% in a wavelength range of 600 to 800 nm

IR20: wavelength at a transmittance of 20% in a wavelength range of 600 to 800 nm

(ii-1) IR50 (IR50_{0deg}) at an incident angle of 0 degree is preferably in a range of 680 to 800 nm, and more preferably in a range of 680 to 770 nm. The cut wavelength of infrared light can be adjusted in the case where the reflection layer has such a characteristic.

(ii-2) IR20 (IR20_{0deg}) at an incident angle of 0 degree is preferably in a range of 700 to 820 nm, and more preferably in a range of 670 to 760 nm. The cut wavelength of infrared light can be adjusted in the case where the reflection layer has such a characteristic.

(ii-3) An absolute value of the difference (IR50_{30deg}−IR50_{0deg}) between IR50 (IR50_{30deg}) at an incident angle of 30 degrees and IR50 (IR50_{0deg}) at an incident angle of 0 degree is preferably 11 nm or more.

(ii-4) An average transmittance of light in a wavelength range of 435 to 500 nm is preferably 88% or more, and more preferably 92% or more. In the case where the reflection layer has such a characteristic, a large amount of visible light can be taken in, which is preferable from the viewpoint of color reproducibility.

In order to satisfy such a characteristic, for example, a squarylium dye having a high visible light transmittance is preferably used.

(ii-5) An average transmittance of light in a wavelength range of 640 to 660 nm is preferably 70% or more, and more preferably 80% or more. In the case where the reflection layer has such a characteristic, a large amount of visible light, particularly light in a wavelength range of 600 to 700 nm can be taken in, which is preferable from the viewpoint of color reproducibility.

In order to satisfy such a characteristic, for example, a dye having a maximum absorption wavelength at 700 to 760 nm is preferable, and a squarylium dye having excellent steepness is preferably used.

(ii-6) An average transmittance of light in a wavelength range of 750 to 1,100 nm is preferably 10% or less, and more preferably 2% or less. In the case where the reflection layer has such a characteristic, infrared light in a wavelength range of 750 to 1,100 nm can be shielded, and flare and ghost can be suppressed.

Furthermore, the transmittance of the reflection layer preferably changes steeply in the boundary wavelength region between the transmission region and the light-shielding region. For this purpose, the total number of laminated layers of the dielectric multilayer film constituting the reflection layer is preferably 15 layers or more, more preferably 25 layers or more, and even more preferably 30 layers or more. However, in the case where the total number of the laminated layers increases, warpage and the like occur and film thickness increases. Therefore, the total number of laminated layers is preferably 100 layers or less, more preferably 75 layers or less, and even more preferably 60 layers or less. The film thickness of the dielectric multilayer film is preferably 2 to 10 μm.

In the case where the total number of the laminated layers and the film thickness of the dielectric multilayer film fall within the above-described ranges, the reflection layer meets the requirements for downsizing, and steepness of the transmittance in the boundary wavelength region between the transmission region and the light-shielding region can be satisfied while maintaining high productivity. Moreover, for forming the dielectric multilayer film, for example, a vacuum film forming process such as a CVD method, a sputtering method and a vacuum vapor deposition method, a wet film forming process such as a spray method and a dip method, or the like can be used.

There may be one layer (a group of dielectric multilayer films) of the reflection layer to provide predetermined optical characteristics or two layers of the reflection layers to provide predetermined optical characteristics. In the case where the optical filter of the present invention has two or more layers of the reflection layers, the reflection layers may have the same structure or different structures from each other. In the case where the optical filter of the present invention has two or more reflection layers, it is usually formed of a plurality of reflection layers having different reflection regions.

As an example, in the case where two reflection layers are provided, one may be a near-infrared reflection layer that shields light in a short wavelength region in the near-infrared region, and the other may be a near-infrared-cum-near-ultraviolet reflection layer that shields light in both regions of a long wavelength region of the near-infrared region and a near-ultraviolet region. Moreover, for example, in the case where the optical filter of the present invention has a transparent substrate and two or more reflection layers are provided, all of the reflection layers may be provided on or above one main surface of the transparent substrate or the reflection layers may be provided on or above both main surfaces with the transparent substrate sandwiched therebetween.

[Antireflection Layer]

The optical filter of the present invention may further include an antireflection layer.

Examples of the antireflection layer include dielectric multilayer films, middle-refractive index media, moth-eye structures in which the refractive index gradually changes, and the like. Among them, the dielectric multilayer film is preferable from the viewpoint of optical efficiency and productivity. The antireflection layer can be obtained by alternately laminating dielectric films as in the reflection layer.

[Other Constituent Elements]

The optical filter of the present invention may include, as other constituent elements, for example, constituent elements (layers) that impart absorption by inorganic fine particles or the like that control transmission and absorption of light in a specific wavelength range. Specific examples of the inorganic fine particles include Indium Tin Oxides (ITO), Antimony-doped Tin Oxides (ATO), cesium tungstate, lanthanum boride, and the like. The ITO fine particles and the cesium tungstate fine particles have a high visible light transmittance and have a light absorptivity over a wide range of an infrared wavelength region exceeding 1,200 nm, and thus can be used in the case where shielding properties for such infrared light are required.

[Optical Filter]

Since the optical filter of the present invention includes an absorption layer containing a near-infrared absorbing dye satisfying specific characteristics and a resin having a high glass transition temperature, the filter has excellent light-shielding properties of near-infrared light and heat resistance.

Here, the optical filter of the present invention preferably satisfies the following characteristics (iii-1) to (iii-7), (iii-8), and (iii-9).

Here, the meanings of IR50, IR20, and UV50 are as follows.

IR50: wavelength at a transmittance of 50% in a wavelength range of 600 to 800 nm

IR20: wavelength at a transmittance of 20% in a wavelength range of 600 to 800 nm

UV50: wavelength at a transmittance of 50% in a wavelength range of 380 to 440 nm

(iii-1) IR50 (IR50_{0deg}) at an incident angle of 0 degree is preferably in a range of 640 to 760 nm, and more preferably in a range of 640 to 730 nm. In the case where the optical filter has such a characteristic, visible light can be taken in and infrared light of 700 nm or longer can be efficiently cut.

(iii-2) IR20 (IR20_{0deg}) at an incident angle of 0 degree is preferably in a range of 660 to 780 nm, and more preferably in a range of 650 to 740 nm. In the case where the optical filter has such a characteristic, visible light can be taken in and infrared light of 700 nm or longer can be efficiently cut.

(iii-3) UV50 (UV50_{0deg}) at an incident angle of 0 degree is preferably in a range of 390 to 430 nm, and more preferably in a range of 390 to 420 nm. In the case where the optical filter has such a characteristic, the oblique-incident characteristic on the UV side is improved and visible light can be taken in a large amount.

(iii-4) An average transmittance of light in a wavelength range of 430 to 500 nm is preferably 82% or more, and more preferably 88% or more. In the case where the optical filter has such a characteristic, a large amount of light in the red band (600 to 700 nm) is taken in and the color reproducibility is excellent.

(iii-5) An average transmittance of light in a wavelength range of 640 to 660 nm is preferably 65% or more, and more preferably 70% or more. In the case where the optical filter has such a characteristic, a large amount of light in the red band (600 to 700 nm) is taken in and the color reproducibility is excellent.

In order to satisfy such a characteristic, it is, for example, mentioned to use a dye having a maximum absorption wavelength in 700 to 760 nm, and preferably to use a squarylium dye having excellent steepness.

(iii-6) A minimum transmittance of light in a wavelength range of 640 to 660 nm is preferably 60% or more, and more preferably 65% or more. In the case where the optical filter has such a characteristic, a large amount of light in the red band (600 to 700 nm) is taken in and the color reproducibility is excellent.

In order to satisfy such a characteristic, it is, for example, mentioned to use a dye having a maximum absorption wavelength in 700 to 760 nm, and preferably to use a squarylium dye having excellent steepness.

(iii-7) An average transmittance of light in a wavelength range of 750 to 1,100 nm is preferably 3% or less, and more preferably 1% or less. In the case where the optical filter has such a characteristic, light of 750 to 1100 nm caused by flare or ghost can be shielded.

(iii-8) An absolute value of the difference (IR50_{30deg}−IR50_{0deg}) between IR50 (IR50_{30deg}) at an incident angle of 30 degrees and IR50 (IR50_{0deg}) at an incident angle of 0 degree is preferably 11 nm or less, and more preferably 5 nm or less. In the case where the optical filter has such a characteristic, it is excellent in the oblique-incident characteristic.

In order to satisfy such a characteristic, it is, for example, mentioned to adjust the shift band of the multilayer film to the absorption of the dye.

(iii-9) An absolute value of the difference (UV50_{0deg}−UV50_{30deg}) between UV50 (UV50_{30deg}) at an incident angle of 30 degrees and UV50 (UV50_{0deg}) at an incident angle of 0 degree is preferably 3 nm or less, and more preferably 2 nm or less. In the case where the optical filter has such a characteristic, it is excellent in the oblique-incident characteristic on the UV side.

In order to satisfy such a characteristic, it is, for example, mentioned to adjust the shift of the multilayer film on the UV side to the absorption region of the UV dye.

The optical filter of the present invention can provide an imaging apparatus having excellent color reproducibility, for example, in the case where the filter is used in an imaging apparatus such as digital still camera. Such an imaging apparatus includes a solid-state image-sensing device, an imaging lens and the optical filter of the present invention. The optical filter of the present invention can be used, for example, by being disposed between the imaging lens and the solid-state image-sensing device or directly attached to the solid-state image-sensing device, the imaging lens or the like of the imaging apparatus via an adhesive layer.

### EXAMPLES

Hereinafter, Examples of the present invention will be described.

For the spectral characteristics, an ultraviolet-visible-near-infrared spectrophotometer UH4150 manufactured by Hitachi High-Tech Science Corporation was used.

In addition, the structure of the dye used in each example and the synthesis method or the source of the dye are shown below. Compounds 1 to 12 are NIR dyes, and Compound 13 is a UV dye.

Compounds 1 and 5: synthesized in accordance with WO 2014/088063 and WO 2016/133099.

Compound 2: synthesized in accordance with WO 2017/135359.

Compound 3: synthesized in accordance with WO 2016/133099.

Compound 4: synthesized in accordance with JP-A-2018-95798

Compound 6, Compound 7, Compound 10: synthesized in accordance with WO 2014/088063

Compound 8: synthesized in accordance with WO 2017/094858

Compound 9: synthesized in accordance with JP-A-2014-59550

Compound 11: synthesized in accordance with WO 2012/169447

Compound 12: FDR003 (phthalocyanine dye) manufactured by Yamada Chemical Co., Ltd.

Compound 13: synthesized in accordance with DE 10109243.

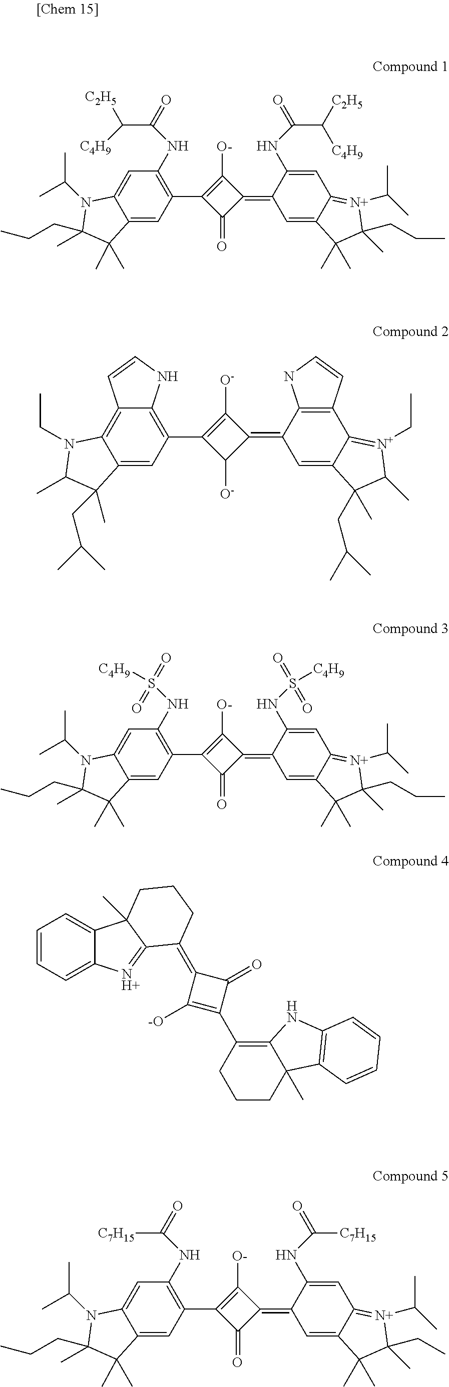

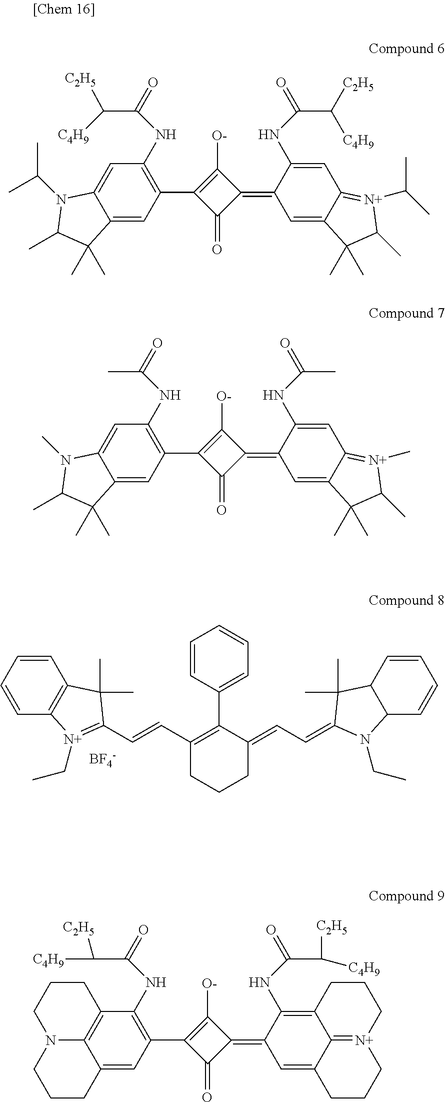

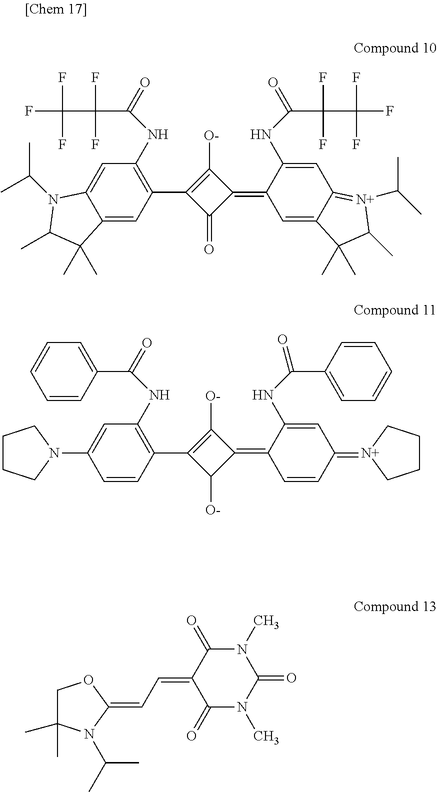

### Example 1-1 to Example 1-12

NIR dyes (Compound 1 to Compound 12) were each uniformly dissolved in dichloromethane. The amount of the dye added was adjusted so that the transmittance of light at the maximum absorption wavelength was 10%. For each of the obtained solutions, each optical characteristic shown in Table 4 was measured by using a spectrophotometer.

The thermal decomposition temperature (° C.) of 5% reduction of the NIR dye was measured by the following method.

Thermal decomposition temperature of 5% reduction of NIR dye: The thermal decomposition temperature was measured with raising the temperature in a rate of 10° C. per minute under a nitrogen flow by using 10 mg of the dye. The temperature at which its weight became 95% of the initial weight was defined as the thermal decomposition temperature of 5% reduction. A differential heat/thermal gravity simultaneous measuring apparatus SDT Q600 (manufactured by TA Instrument Japan) was used for the measurement of the thermal decomposition temperature.

Table 4 shows the results.

Compounds 1 to 7 are dyes that satisfy all of the above characteristics (i-1) to (i-3).

TABLE 4

| | Example | Example | Example | Example | Example | Example |
|---|---|---|---|---|---|---|
| | 1-1 | 1-2 | 1-3 | 1-4 | 1-5 | 1-6 |
| NIR dye | Compound | Compound | Compound | Compound | Compound | Compound |
| | 1 | 2 | 3 | 4 | 5 | 6 |
| Maximum | 714 | 742 | 705 | 692 | 713 | 706 |
| absorption | | | | | | |
| wavelength | | | | | | |
| in DCM (nm) | | | | | | |
| IR80 in DCM (nm) | 666 | 671 | 654 | 614 | 665 | 658 |
| IR20 in DCM (nm) | 703 | 729 | 694 | 677 | 702 | 695 |
| Difference of | 37 | 58 | 40 | 63 | 37 | 37 |
| IR20-IR80 (nm) | | | | | | |
| Thermal | 322 | 274 | 275 | 281 | 309 | 284 |
| decomposition | | | | | | |
| temperature of | | | | | | |
| 5% reduction of | | | | | | |
| NIR dye (° C.) | | | | | | |
| T400-500 | 97.2 | 98.8 | 98.1 | 98.1 | 97.3 | 98.6 |
| AVE in DCM (%) | | | | | | |
| T400-500 | 93.8 | 96.9 | 94.9 | 95.6 | 93.9 | 94.9 |
| MIN in DCM (%) | | | | | | |
| | Example | Example | Example | Example | Example | Example |
| | 1-7 | 1-8 | 1-9 | 1-10 | 1-11 | 1-12 |
| NIR dye | Compound | Compound | Compound | Compound | Compound | Compound |
| | 7 | 8 | 9 | 10 | 11 | 12 |
| Maximum | 698 | 766 | 706 | 711 | 680 | 695 |
| absorption | | | | | | |
| wavelength | | | | | | |
| in DCM (nm) | | | | | | |
| IR80 in DCM (nm) | 637 | 681 | 653 | 664 | 638 | 612 |
| IR20 in DCM (nm) | 686 | 750 | 693 | 700 | 669 | 686 |
| Difference of | 49 | 69 | 40 | 36 | 31 | 74 |
| IR20-IR80 (nm) | | | | | | |
| Thermal | 273 | none | 232 | 258 | 262 | 400 |
| decomposition | | | | | | |
| temperature of | | | | | | |
| 5% reduction of | | | | | | |
| NIR dye (° C.) | | | | | | |
| T400-500 | 97.4 | 98.7 | 99.1 | 98.0 | 98.1 | 96.8 |
| AVE in DCM (%) | | | | | | |
| T400-500 | 93.5 | 96.7 | 96.8 | 95.7 | 95.5 | 87.9 |
| MIN in DCM (%) | | | | | | |

From the results shown in Table 4, it can be found that Compounds 1 to 7 are excellent in heat resistance, steepness of change in transmittance near the boundary between the visible region and the near infrared region (IR20−IR80), and visible light transmittance.

Moreover, Compounds 9 to 11 are inferior in heat resistance. Compounds 8 and 12 are inferior in the steepness of change in transmittance.

As described above, it can be found that those satisfying all of heat resistance, steepness of change in transmittance, and visible light transmittance are specific squarylium dyes.

### Example 2-1

A polyimide resin (polyimide varnish H520 manufactured by Mitsubishi Gas Chemical Company, Inc.) was diluted with cyclohexanone, and Compound 1 as an NIR dye in an amount of 2.68% by mass based on the resin and a silane coupling agent (KBM403 manufactured by Shin-Etsu Chemical Co., Ltd.) as a silane compound in an amount of 10% by mass based on the resin were dissolved therein. The obtained preparation liquid was spin-coated on D263 glass manufactured by SCHOTT to form a film by spin-coating so as to have a film thickness of about 1.0 μm, thereby forming an absorption layer. For the obtained absorption layer, the transmittance and reflectance were measured on a spectrophotometer in a wavelength range of 350 nm to 1,200 nm while tilting the sample at 5 degrees with respect to the incident direction.

The spectral characteristics in the resin were evaluated by the internal transmittance in order to avoid the influence of reflection at the air interface and the glass interface.

Internal transmittance=(Measured transmittance/(100−Measured reflectance))×100

The obtained data was standardized so that the minimum transmittance in a wavelength of 800 to 1,200 nm was 10%.

Moreover, the obtained substrate with an absorption layer was heated to 260° C., and the residual rate of the dye after 5 minutes was converted.

As a conversion of the residual rate, the amount of change in ABS=−log₁₀ (T/100) of the dye at the maximum absorption wavelength was calculated by ABS (after heating)/ABS (after heating).

### Example 2-2, Example 2-3

The evaluation was carried out in the same manner as in Example 2-1 except that the kind of the polyimide resin and the blending amount of Compound 1 were as shown in Table 5.

### Example 2-4

The evaluation was carried out in the same manner as in Example 2-1 except that the NIR dye was changed to Compound 2 and the blending amount was as shown in Table 5.

### Example 2-5, Example 2-6

The evaluation was carried out in the same manner as in Example 2-4 except that the kind of the polyimide resin and the blending amount of Compound 2 were as shown in Table 5.

### Example 2-7

The evaluation was carried out in the same manner as in Example 2-6 except that the NIR dye was changed to Compound 3.

### Example 2-8

The evaluation was carried out in the same manner as in Example 2-6 except that the NIR dye was changed to Compound 8.

Table 5 shows the spectral characteristics and the residual rate obtained in each example.

TABLE 5

| | Example | Example | Example | Example | Example | Example | Example | Example |
|---|---|---|---|---|---|---|---|---|
| | 2-1 | 2-2 | 2-3 | 2-4 | 2-5 | 2-6 | 2-7 | 2-8 |
| Resin name | H520 | H230 | H550 | H520 | H230 | H550 | H550 | H550 |
| Resin structure | polyimide | polyimide | polyimide | polyimide | polyimide | polyimide | polyimide | polyimide |
| Resin Tg (° C.) | 418 | 422 | 424 | 418 | 422 | 424 | 424 | 424 |
| NIR dye | Compound | Compound | Compound | Compound | Compound | Compound | Compound | Compound |
| | 1 | 1 | 1 | 2 | 2 | 2 | 3 | 8 |
| Thermal decomposition | 322 | 322 | 322 | 274 | 274 | 274 | 275 | / |
| temperature of 5% | | | | | | | | |
| reduction of NIR dye (° C.) | | | | | | | | |
| NIR dye concentration (wt %) | 2.68 | 3.27 | 7.5 | 2.43 | 2.87 | 7.5 | 7.5 | 7.5 |
| Silane compound | 10 | 10 | 10 | 10 | 10 | 10 | 10 | 10 |
| concentration (wt %) | | | | | | | | |
| Maximum absorption | 720 | 719 | 723 | 755 | 750 | 755 | 713 | 780 |
| wavelength in resin (nm) | | | | | | | | |
| IR20 in resin (nm) | 701 | 699 | 703 | 731 | 729 | 732 | 696 | 753 |
| IR800 in resin (nm) | 648 | 644 | 651 | 658 | 656 | 667 | 642 | 643 |
| Difference of IR20-IR80 (nm) | 53 | 55 | 52 | 73 | 73 | 65 | 54 | 110 |
| Residual rate of NIR dye | 99.0% | 98.3% | 97.3% | 91.5% | 89.7% | 91.1% | 97.6% | 22.6% |
| at 260° C. after 5 minutes | | | | | | | | |
| T400-500 AVE in resin (%) | 94.5 | 94.8 | 94.7 | 96.0 | 96.4 | 96.5 | 95.7 | 94.4 |
| T400-500 MIN in resin (%) | 89.3 | 89.7 | 89.9 | 92.8 | 94.0 | 94.2 | 91.3 | 90.9 |

From the above-described results, it can be found that the absorption layers of Example 2-1 to Example 2-7, which were formed by combining a resin having a high glass transition temperature and a squarylium compound satisfying the heat resistance and specific spectral characteristics confirmed in Example 1-1 and the like, are less likely to thermally deteriorate, and can achieve both the steepness of change in transmittance and the visible light transmittance.

The absorption layer of Example 2-8 using Compound 8 (cyanine dye) as the NIR dye showed a result that the heat resistance was low even when it was combined with a resin having a high glass transition temperature.

### Example 3-1, Example 3-2

A reflection layer was produced by forming a dielectric multilayer film made of SiO₂/TiO2 by vapor deposition.

Table 6 shows the optical characteristics of the reflection layers obtained in Example 3-1 and Example 3-2.

TABLE 6

| Configuration of reflection layer | Example 3-1 | Example 3-2 |
|---|---|---|
| Substrate | glass | glass |
| IR50 (0 deg) (nm) | 759.5 | 709.5 |
| IR50 (30 deg) (nm) | 730.5 | 684.8 |
| IR50 (30 deg) - IR50 (0 deg) (nm) | 29.0 | 24.6 |
| IR20 (0 deg) (nm) | 766.5 | 725 |
| UV50 (0 deg) (nm) | 409.5 | 408.5 |
| UV50 (30 deg) (nm) | 397.5 | 396.5 |
| UV50 (0 deg) - UV50 (30 deg) (nm) | 12 | 12.0 |
| T435-500 AVE (nm) | 94.3 | 93.7 |
| T640-660 AVE (nm) | 94.6 | 94.7 |
| T640-660 MM (nm) | 0.0 | 0.0 |
| T750-1100 AVE (nm) | 3.55 | 0.38 |

### Example 4-1

The reflection layer shown in Example 3-2 was deposited on a D263 glass plate (76 mm square) manufactured by SCHOTT.

A polyimide resin (polyimide varnish H550 manufactured by Mitsubishi Gas Chemical Company, Inc.) was diluted with cyclohexanone, and Compound 1 as an NIR dye in an amount of 7.5% by mass based on the resin, Compound 13 as a UV dye in an amount of 3.6% by mass based on the resin, and a silane coupling agent (KBM403 manufactured by Shin-Etsu Chemical Co., Ltd.) as a silane compound in an amount of 3% by mass based on the resin were dissolved therein. The obtained preparation liquid was spin-coated on the surface of the glass substrate with a reflection film on which the reflection film was not formed, to form a film by spin coating so as to have a film thickness of about 1.0 μm, thereby forming an absorption layer.

An antireflection layer was formed by alternately depositing 7 layers of SiO₂/TiO₂ as a material on the surface on which the absorption layer was formed, thereby obtaining an optical filter.

The obtained optical filter was cut into 100 pieces and a tape peeling test (peel test) was confirmed.

Similarly, after cutting the optical filter into 100 pieces, they were submerged in boiling water and then a tape peeling test (boiling peel test) was carried out.

The indexes of the peel test and the boiling peel test are shown below.

Less than 10 peelings: A

10 or more peelings: B

In addition, as a heating test, the optical filter was heated at 260° C. for 5 minutes, and appearance abnormality was confirmed.

### Example 4-2

The same evaluation as in Example 4-1 was carried out except that the concentration of Compound 1 was changed as shown in Table 7 and no UV dye was added.

### Example 4-3

The same evaluation as in Example 4-2 was carried out except that the concentration of the silane compound was changed as shown in Table 7.

### Example 4-4

The same evaluation as in Example 4-2 was carried out except that Compound 2 was used as the NIR dye and the concentration was changed as shown in Table 7.

### Example 4-5

The same evaluation as in Example 4-4 was carried out except that the concentration of the silane compound was changed as shown in Table 7.

### Example 4-6

The same evaluation as in Example 4-1 was carried out except that the kind of the polyimide resin was changed as shown in Table 7.

### Example 4-7

The same evaluation as in Example 4-6 was carried out except that no silane compound was blended.

Table 7 shows the results of the peel test, the boiling peel test, and the heating test obtained in each example.

Incidentally, Example 4-1 to Example 4-5 are Invention Examples, and Example 4-6 and Example 4-7 are Comparative Examples.

TABLE 7

| | Example 4-1 | Example 4-2 | Example 4-3 | Example 4-4 | Example 4-5 | Example 4-6 | Example 4-7 |
|---|---|---|---|---|---|---|---|
| Resin name | H550 | H550 | H550 | H550 | H550 | C3G30G | C3G30G |
| Resin structure | polyimide | polyimide | polyimide | polyimide | polyimide | polyimide | polyimide |
| Resin Tg (° C.) | 424 | 424 | 424 | 424 | 424 | 320 | 320 |
| NIR dye | Compound 1 | Compound 1 | Compound 1 | Compound 2 | Compound 2 | Compound 1 | Compound 1 |
| Thermal decomposition | 322 | 322 | 322 | 274 | 274 | 322 | 322 |
| temperature of 5% | | | | | | | |
| reduction of NIR dye (° C.) | | | | | | | |
| NIR dye concentration (wt %) | 7.5 | 3.48 | 3.48 | 2.88 | 2.88 | 7.5 | 7.5 |
| UV dye | Compound 13 | — | — | — | — | Compound 13 | Compound 13 |
| UV dye concentration (wt %) | 3.6 | 0 | 0 | 0 | 0 | 3.6 | 3.6 |
| Silane compound | 3 | 3 | 10 | 3 | 10 | 3 | 0 |
| concentration (wt %) | | | | | | | |
| Constitution of reflection layer | Example 3-2 | Example 3-2 | Example 3-2 | Example 3-2 | Example 3-2 | Example 3-2 | Example 3-2 |
| Peel test | A | A | A | A | A | A | A |
| Boiling peel test | A | A | A | A | A | A | B |
| Heating test at 260° C. | No | No | No | No | No | Generation of | Occurrence of |
| for 5 minutes | abnormality | abnormality | abnormality | abnormality | abnormality | bubbles | peeling |

From the above-described results, the optical filters of Example 4-1 to Example 4-5, which contain a silane compound, showed good results in the peel test and the boiling peel test. From this fact, it can be found that the adhesiveness to the substrate is enhanced in the case where the absorption layer contains a silane compound.

On the other hand, the optical filter of Example 4-6 using a resin having a low thermal decomposition temperature showed good results in the peel test and the boiling peel test, but bubbles were generated in the heating test. From this fact, it can be found that even in the case where the absorption layer contains a silane compound, the silane compound volatilizes and appearance abnormality is generated when the heat resistance of the resin is low.

Furthermore, the optical filter of Example 4-7 using a resin having a low thermal decomposition temperature and containing no silane compound showed poor results in the heating test and the boiling peel test.

### Example 5-1 to Example 5-3

For the optical filters produced in the same manner as in Example 4-1 except that the configurations shown in Table 8 were adopted, transmittances at incident angles of 0 deg and 30 deg in a wavelength range of 350 nm to 1,200 nm were measured by using a spectrophotometer. The incident angle of 0 deg means incident angle of light entering in the direction perpendicular to the substrate surface.

Table 8 shows the optical characteristics of the optical filters of Example 5-1 to Example 5-3.

Incidentally, Example 5-1 to Example 5-3 are Invention Examples.

TABLE 8

| | | Example 5-1 | Example 5-2 | Example 5-3 |
|---|---|---|---|---|
| Substrate | | glass | glass | glass |
| Absorption | Resin name | H550 | H550 | H550 |
| layer | Resin structure | polyimide | polyimide | polyimide |
| | Resin Tg (° C.) | 424 | 424 | 424 |
| | NIR dye | Compound 2 | Compound 1 | Compound 2 |
| | Thermal decomposition temperature of | 322 | 322 | 322 |
| | 5% reduction of NIR dye (° C.) | | | |
| | NIR dye concentration (wt %) | 2.88 | 3.48 | 2.88 |
| | UV dye | — | — | Compound 13 |
| | UV dye concentration (wt %) | 0 | 0 | 2.5 |
| | Silane compound concentration (wt %) | 3 | 3 | 3 |
| Configuration of reflection layer | | Example 3-1 | Example 3-2 | Example 3-1 |
| Optical | IR50 (0 deg) (nm) | 713.1 | 685.8 | 714.0 |
| properties | IR50 (30 deg) (nm) | 710.7 | 675.9 | 712.5 |
| | IR50 (30 deg) - IR50 (0 deg) (nm) | 2.40 | 9.87 | 1.50 |
| | IR20 (0 deg) (nm) | 725.4 | 701.3 | 725.5 |
| | UV50 (0 deg) (nm) | 408.1 | 408.6 | 415.2 |
| | UV50 (30 deg) (nm) | 396.7 | 397.0 | 414.8 |
| | UV50 (0 deg) - UV50 (30 deg) (nm) | 11.45 | 11.61 | 0.42 |
| | T435-500 AVE (nm) | 93.9 | 93.7 | 93.6 |
| | T640-660 AVE (nm) | 87.56 | 80.79 | 86.45 |
| | T640-660 Min (nm) | 83.54 | 74.80 | 82.54 |
| | T750-1100 AVE (nm) | 0.65 | 0.34 | 0.63 |

From the above-described results, all of the optical filters of Example 5-1 to Example 5-3 can be optical filters having a high red light transmittance of T640-660 nm while maintaining a high visible light transmittance of T435-500 nm.

### Example 6-1 to Example 6-4

Optical filters were produced in the same manner as in Example 4-1 except that the configurations shown in Table 9 were adopted.

For each of the obtained optical filters, the transmittance at an incident angle of 0 deg was measured in a wavelength range of 350 nm to 1,200 nm by using a spectrophotometer.

Each of the obtained optical filters was heated on a hot plate under conditions of 260° C. and 5 minutes to perform a thermal deterioration test that simulated a solder reflow process, thereby evaluating a degree of thermal deterioration. As evaluation indexes, variations in IR50 and IR20 before and after the reflow were used. Both the variation in IR50 and the variation in IR20 are preferably 0.8 nm or less. In addition, the appearance after reflow was confirmed and the presence or absence of bubbles was evaluated.

Table 9 shows the optical characteristics and the results of the thermal deterioration test.

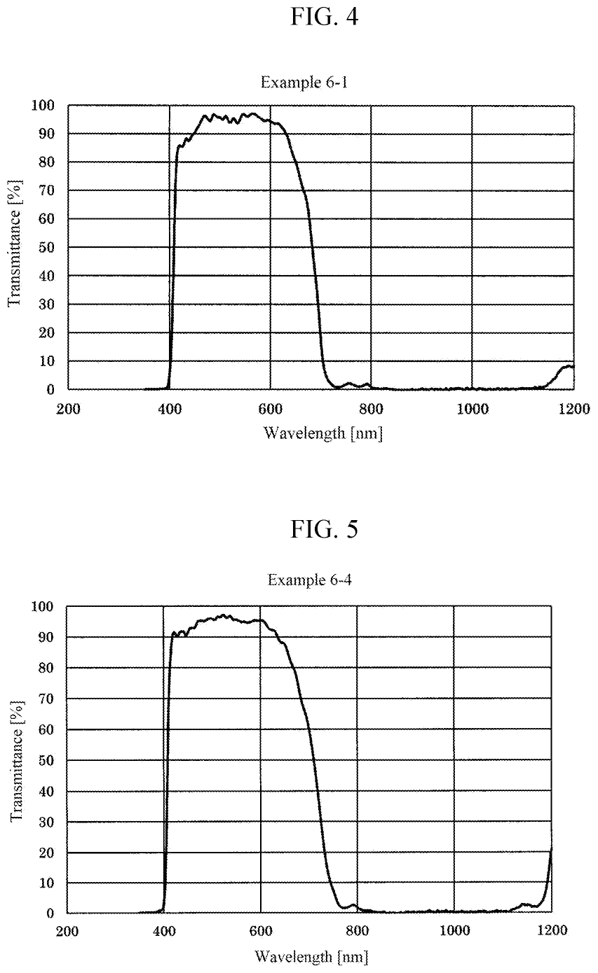

The spectral transmittance curves of the optical filters of Example 6-1 and Example 6-4 are shown in FIG. 4 and FIG. 5, respectively.

Example 6-1 and Example 6-3 are Invention Examples, and Example 6-2 and Example 6-4 are Comparative Examples.

TABLE 9

| | | Example 6-1 | Example 6-2 | Example 6-3 | Example 6-4 |
|---|---|---|---|---|---|
| Substrate | | glass | glass | glass | glass |
| Absorption | Resin name | H550 | C3G30G | H550 | C3G30G |
| layer | Resin structure | polyimide | polyimide | polyimide | polyimide |
| | Resin Tg (° C.) | 424 | 320 | 424 | 320 |
| | NIR dye | Compound 1 | Compound 1 | Compound 2 | Compound 2 |
| | Thermal decomposition | 322 | 322 | 274 | 274 |
| | temperature of 5% reduction | | | | |
| | of NIR dye (° C.) | | | | |
| | NIR dye concentration (wt %) | 3.48 | 4.8 | 2.88 | 3.7 |
| | Silanc compound | 10 | 10 | 10 | 10 |
| | concentration (wt %) | | | | |
| Configuration of reflection layer | | Example 3-1 | Example 3-1 | Example 3-2 | Example 3-2 |
| Optical | IR50 (0 deg) (nm) | 683.1 | 677.4 | 710.1 | 699.7 |
| properties | IR20 (0 deg) (nm) | 698.8 | 695.4 | 725.3 | 724.5 |
| | UV50 (0 deg) (nm) | 408.7 | 408.5 | 407.8 | 407.6 |
| | T435-500 AVE (nm) | 93.5 | 94.4 | 93.8 | 94.6 |
| | T640-660 AVE (nm) | 79.8 | 74.8 | 86.9 | 84.1 |
| | T640-660 MM (nm) | 73.5 | 67.1 | 83.3 | 78.7 |
| | T750-1100 AVE (nm) | 0.4 | 0.4 | 0.6 | 0.5 |
| Thermal | Variation in IR50 with reflow | 0.10 | 0.97 | 0.06 | 0.83 |
| deterioration | Variation in IR20 with reflow | −0.08 | 0.59 | 0.00 | 1.55 |
| test | Bubble generation after reflow | absent | present | absent | present |

From the above-described results, in the optical filters of Example 6-1 and Example 6-3 in which the absorption layer was formed by combining a resin having a high glass transition temperature and an NIR dye having a high thermal decomposition temperature, no bubbles were generated even in the reflow step, and IR20 and IR50 were also hardly varied.

On the other hand, as shown in Example 6-2 and Example 6-4, in the case where the glass transition temperature of the resin was low even when an NIR dye having a high thermal decomposition temperature was used, bubbles were generated in the reflow process and IR20 and IR50 also varied. It is considered that this is because thermal collision is likely to occur in the resin having a low glass transition temperature even when the thermal decomposition temperature of the dye is high, and the thermal decomposition of the dye is promoted.

Although the present invention has been specifically described with reference to particular embodiments, it will be apparent to those skilled in the art that various changes and modifications can be made without departing from the gist and scope of the invention. This application is based on Japanese Patent Application (No. 2019-165682) filed on Sep. 11, 2019, the content of which is incorporated herein by reference.

### INDUSTRIAL APPLICABILITY

The optical filter of the present invention has excellent shielding properties of near-infrared light and excellent heat resistance, while maintaining good transmission of visible light, particularly red transmission. It is useful for applications of information acquisition devices for transport aircraft, such as cameras and sensors whose performance has been improved in recent years.

### REFERENCE SIGNS LIST

10A, 10B, 10C Optical filter
11 Absorption layer
12 Transparent substrate
13 Reflection layer
14 Antireflection layer

What is claimed is:

1. An optical filter comprising an absorption layer comprising a near-infrared absorbing dye and a resin,
wherein the near-infrared absorbing dye comprises a squarylium dye satisfying all of the following characteristics (i-1) to (i-3) and
the resin has a glass transition temperature of 390° C. or higher:
(i-1) when spectral transmittance is measured after dissolving in dichloromethane, the squarylium dye has a maximum absorption wavelength in 650 to 780 nm;
(i-2) the squarylium dye has a thermal decomposition temperature of 265° C. or higher; and
(i-3) in a spectral transmittance curve measured when the squarylium dye is dissolved in dichloromethane so that a transmittance at the maximum absorption wavelength is 10%, IR20−IR80<65 nm is satisfied, where IR80 represents a wavelength at a transmittance of 80% in a wavelength range of 600 to 800 nm and IR20 represents a wavelength at a transmittance of 20% in the wavelength range of 600 to 800 nm.

2. The optical filter according to claim 1,
wherein the squarylium dye satisfies all of the following characteristics (i-4) to (i-6) in the spectral transmittance curve measured when the squarylium dye is dissolved in dichloromethane so that a transmittance at the maximum absorption wavelength is 10%:
(i-4) IR20−IR80<60 nm is satisfied;
(i-5) an average transmittance of light in a wavelength range of 400 to 500 nm is 96% or more; and
(i-6) a minimum transmittance of light in the wavelength range of 400 to 500 nm is 93% or more.

3. The optical filter according to claim 1,
wherein the squarylium dye satisfies all of the following characteristics (i-7) to (i-11) in a spectral transmittance curve measured when the squarylium dye is dissolved in a resin so that transmittance at the maximum absorption wavelength is 10%:
(i-7) a maximum absorption wavelength is in a range of 650 to 790 nm;
(i-8) IR20 is in a range of 630 to 770 nm;
(i-9) IR20−IR80<80 nm is satisfied;
(I-10) an average transmittance of light in a wavelength range of 400 to 500 nm is 90% or more; and
(i-11) a minimum transmittance of light in the wavelength range of 400 to 500 nm is 85% or more.

4. The optical filter according to claim 1,
wherein the squarylium dye is a compound represented by the following Formula (I) or (II): 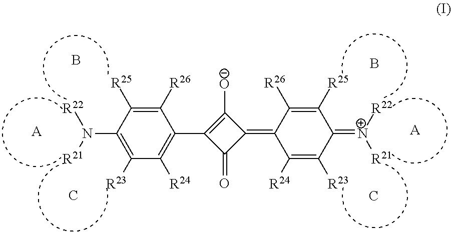
wherein, symbols in Formula (I) are as follows:
R²⁴ and R²⁶ each independently represents a hydrogen atom, a halogen atom, a hydroxy group, an alkyl group or alkoxy group having a carbon number of 1 to 6, an acyloxy group having a carbon number of 1 to 10, —NR²⁷R²⁸ (R²⁷ and R²⁸ each independently represents a hydrogen atom, an alkyl group having a carbon number of 1 to 20, —C(═O)—R²⁹ (R²⁹ represents a hydrogen atom or a hydrocarbon group having a carbon number of 1 to 25 which may have a substituent and may contain an unsaturated bond, an oxygen atom, or a saturated or unsaturated ring structure between carbon atoms), —NR³⁰, or —SO₂—R³⁰ (R³⁰ represents a hydrocarbon group having a carbon number of 1 to 25, each of which one or more hydrogen atoms may be substituted with a halogen atom, a hydroxy group, a carboxy group, a sulfo group, or a cyano group, and which may contain an unsaturated bond, an oxygen atom, or a saturated or unsaturated ring structure between carbon atoms)), or a group represented by the following Formula (S) (R⁴¹ and R⁴² each independently represents a hydrogen atom, a halogen atom, or an alkyl group or alkoxy group having a carbon number of 1 to 10, and k is 2 or 3): 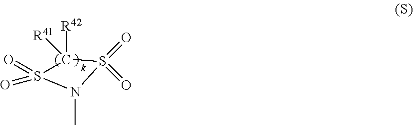
wherein R²¹ and R²², R²² and R²⁵, and R²¹ and R²³ may be bonded to each other to form a heterocycle A, a heterocycle B, and a heterocycle C each having 5 or 6 members together with the nitrogen atom, respectively,
R²¹ and R²² in the case where the heterocycle A is formed represent, as a divalent group -Q- to which they are bonded, an alkylene group or alkyleneoxy group in which a hydrogen atom may be substituted with an alkyl group having a carbon number of 1 to 6, an aryl group having a carbon number of 6 to 10, or an acyloxy group having a carbon number of 1 to 10 which may have a substituent,
R²² and R^{2S} in the case where the heterocycle B is formed, and R²¹ and R²³ in the case where the heterocycle C is formed respectively represent, as divalent groups —X¹—Y¹— and —X²—Y²— (X¹ and X² are on the side that bonds to nitrogen) to which they are bonded, a group in which X¹ and X² are each a group represented by the following Formula (1x) or (2x), and Y¹ and Y² are each a group represented by any one selected from the following Formulae (1y) to (5y), and in the case where X¹ and X² are each a group represented by the following Formula (2x), Y¹ and Y² may be a single bond, and in that case, an oxygen atom may be contained between carbon atoms: 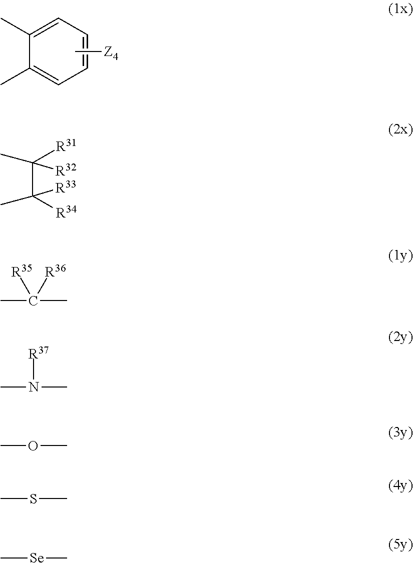
wherein in Formula (1x), four Z's each independently represents a hydrogen atom, a hydroxy group, an alkyl group or alkoxy group having a carbon number of 1 to 6, or —NR³⁸R³⁹ (R³⁸ and R³⁹ each independently represents a hydrogen atom or an alkyl group having a carbon number of 1 to 20), R³¹ to R³⁶ each independently represents a hydrogen atom, an alkyl group having a carbon number of 1 to 6 or an aryl group having a carbon number of 6 to 10, and R³⁷ represents an alkyl group having a carbon number of 1 to 6 or an aryl group having a carbon number of 6 to 10,
R²⁷, R²⁸, R⁹, R³¹ to R³⁷, R²¹ to R²³ in the case where a heterocycle is not formed, and R²¹ may be bonded to any other of them to form a 5-membered ring or a 6-membered ring, and R³¹ and R³⁶, and R³¹ and R³⁷ may be directly bonded to each other, and
R²¹ and R²² in the case where a heterocycle is not formed, each independently represents a hydrogen atom, an alkyl group or allyl group having a carbon number of 1 to 6 which may have a substituent, or an aryl group or araryl group having a carbon number of 6 to 11 which may have a substituent, and R²³ and R²⁵ in the case where a heterocycle is not formed, each independently represents a hydrogen atom, a halogen atom, or an alkyl group or alkoxy group having a carbon number of 1 to 6; and 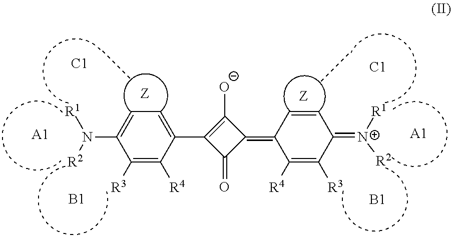
wherein, symbols in Formula (II) are as follows:
ring Z's each independently represents a 5-membered ring or 6-membered ring which has 0 to 3 heteroatoms in the ring and the hydrogen atom(s) contained in the ring Z may be substituted,
R¹ and R², R² and R³, and R¹ and a carbon atom or heteroatom constituting the ring Z may be boded to each other to form a heterocycle A1, a heterocycle B1 and a heterocycle C₁ together with the nitrogen atom, respectively, and in that case, the hydrogen atom(s) contained in the heterocycle A1, the heterocycle B1 and the heterocycle C1 may be substituted, R¹ and R² in the case where the heterocycle is not formed, each independently represents a hydrogen atom, a halogen atom, or a hydrocarbon group which may contain an unsaturated bond, a heteroatom, or a saturated or unsaturated ring structure between carbon atoms, and may have a substituent, and R⁴, and R³ in the case where the heterocycle is not formed, each independently represents a hydrogen atom, a halogen atom, or an alkyl group or alkoxy group which may contain a heteroatom between carbon atoms and may have a substituent.

5. The optical filter according to claim 1,
further comprising a transparent substrate,
wherein the absorption layer is provided on or above a main surface of the transparent substrate.

6. The optical filter according to claim 5,
wherein the transparent substrate is a glass or an absorption glass.

7. The optical filter according to claim 1,
wherein the resin comprises at least one selected from the group consisting of a polyimide resin, a polyamide resin, polyethylene naphthalate, a polyether sulfone, a polyether, an epoxy resin, and a cycloolefin resin.

8. The optical filter according to claim 1,
wherein the resin comprises a polyimide resin.

9. The optical filter according to claim 1,
wherein the absorption layer further comprises a silicon compound, and
a content of the silicon compound in the absorption layer is 15% by mass or less.

10. The optical filter according to claim 1,
wherein the absorption layer further comprises a compound having a maximum absorption wavelength in 350 to 450 nm when spectral transmittance is measured after dissolving in dichloromethane.

11. The optical filter according to claim 1,
wherein the absorption layer further comprises a compound having a maximum absorption wavelength in 800 to 1,200 nm when spectral transmittance is measured after dissolving in dichloromethane.

12. The optical filter according to claim 1,
further comprising a reflection layer,
wherein the reflection layer satisfies all of the following characteristics (ii-1) to (ii-6), where IR50 represents a wavelength at a transmittance of 50% in the wavelength range of 600 to 800 nm and IR20 represents a wavelength at a transmittance of 20% in the wavelength range of 600 to 800 nm:
(ii-1) IR50 (IR50_{0deg}) at an incident angle of 0 degree is in a range of 680 to 800 nm;
(ii-2) IR20 (IR20_{0deg}) at an incident angle of 0 degree is in a range of 700 to 820 nm;
(ii-3) an absolute value of the difference between IR50 (IR50_{30deg}) at an incident angle of 30 degrees and IR50 (IR50_{0deg}) at an incident angle of 0 degree is 11 nm or more;
(ii-4) an average transmittance of light in a wavelength range of 435 to 500 nm is 88% or more;
(ii-5) an average transmittance of light in a wavelength range of 640 to 660 nm is 70% or more; and
(ii-6) an average transmittance of light in a wavelength range of 750 to 1,100 nm is 10% or less.

13. The optical filter according to claim 1,
satisfying all of the following characteristics (iii-1) to (iii-7), where IR50 represents a wavelength at a transmittance of 50% in the wavelength range of 600 to 800 nm, IR20 represents a wavelength at a transmittance of 20% in the wavelength range of 600 to 800 nm, and UV50 represents a wavelength at a transmittance of 50% in a wavelength range of 380 to 440 nm:
(iii-1) IR50 (IR50_{0deg}) at an incident angle of 0 degree is in a range of 640 to 760 nm;
(iii-2) IR20 (IR20_{0deg}) at an incident angle of 0 degree is in a range of 660 to 780 nm;
(iii-3) UV50 (UV50_{0deg}) at an incident angle of 0 degree is in a range of 390 to 430 nm;
(iii-4) an average transmittance of light in a wavelength range of 430 to 500 nm is 82% or more;
(iii-5) an average transmittance of light in a wavelength range of 640 to 660 nm is 65% or more;
(iii-6) a minimum transmittance of light in the wavelength range of 640 to 660 nm is 60% or more; and
(iii-7) an average transmittance of light in a wavelength range of 750 to 1,100 nm is 3% or less.

14. The optical filter according to claim 1,
satisfying the following characteristic (iii-8), where IR50 represents a wavelength at a transmittance of 50% in the wavelength range of 600 to 800 nm:
(iii-8) an absolute value of the difference between IR50 (IR50_{30deg}) at an incident angle of 30 degrees and IR50 (IR50_{0deg}) at an incident angle of 0 degree is 11 nm or less.

15. The optical filter according to claim 1,
satisfying the following characteristic (iii-9), where UV50 represents a wavelength at a transmittance of 50% in a wavelength range of 380 to 440 nm:
(iii-9) an absolute value of the difference between UV50 (UV50_{30deg}) at an incident angle of 30 degrees and UV50 (UV50_{0deg}) at an incident angle of 0 degree is 3 nm or less.

16. An imaging apparatus, comprising the optical filter described in claim 1.
